(19) United States
(12) Patent Application Publication
(10) Pub. No.: US 2022/0214527 A1
(43) Pub. Date: Jul. 7, 2022

(54) Lens system, imaging module, and electronic device

(71) Applicant: JIANGXI JINGCHAO OPTICAL CO., LTD., Nanchang (CN)

(72) Inventors: Lu HUA, Nanchang (CN); Jian YANG, Nanchang (CN); Ming LI, Nanchang (CN); Hairong ZOU, Nanchang (CN)

(73) Assignee: JIANGXI JINGCHAO OPTICAL CO., LTD., Nanchang (CN)

(21) Appl. No.: 17/611,165

(22) PCT Filed: Mar. 16, 2020
(86) PCT No.: PCT/CN2020/079526

§ 371 Date: Nov. 14, 2021

(51) Int. Cl. G02B 13/00; G02B 9/14

(52) U.S. Cl. CPC G02B 13/0065; G02B 9/14; G02B 13/0035

(57) ABSTRACT

A lens system includes, sequentially from an object side to an image side, a first optical path folding element located on a first part of the folded optical axis and configured to direct light from the first part of the folded optical axis to a second part of the folded optical axis; a lens group located on the second part of the folded optical axis; a second optical path folding element configured to direct light from the second part of the folded optical axis to a third part of the folded optical axis; and a third optical path folding element configured to direct light from the third part of the folded optical axis to a fourth part of the folded optical axis. The second part, the third part, and the fourth part are located within a same plane that is perpendicular to the first part.

### CROSS REFERENCE TO RELATED APPLICATION

This application is a national stage, filed under 35 U.S.C. § 371, of International Application No. PCT/CN2020/079526, filed on Mar. 16, 2020, and entitled “LENS SYSTEM, IMAGING MODULE, AND ELECTRONIC DEVICE”, the content of which is incorporated herein in entirety by reference.

### TECHNICAL FIELD

The present disclosure relates to the field of optical imaging technologies, and more particularly, to a lens system, an imaging module, and an electronic device.

### BACKGROUND

In recent years, with the development of science and technology, periscopic mobile phone lenses are increasingly used in portable electronic products. The periscopic mobile phone lens has a prism part that can change a transmission direction of an optical path, and the lens can be transversely arranged in a housing of the electronic product during mounting, so that the transverse length and overall height of the lens are reduced, thereby achieving a light and thin mobile phone.

However, under the development trend of becoming thinner and lighter for the electronic products, it is still difficult for conventional periscopic lenses to achieve a long focal length or an ultra-long focal length.

### SUMMARY

According to various embodiments of the present disclosure, a lens system is provided.

A lens system includes a plurality of optical elements arranged along a folded optical axis of the lens system, and the plurality of optical elements includes sequentially from an object side to an image side:

a first optical path folding element, located on a first part of the folded optical axis, the first optical path folding element being configured to direct light from the first part of the folded optical axis to a second part of the folded optical axis;

a lens group, located on the second part of the folded optical axis;

a second optical path folding element, configured to direct light from the second part of the folded optical axis to a third part of the folded optical axis; and

a third optical path folding element, configured to direct light from the third part of the folded optical axis to a fourth part of the folded optical axis;

where the second part, the third part, and the fourth part of the folded optical axis are located within a same plane, and the plane is perpendicular to the first part of the folded optical axis.

An imaging module includes a photosensitive element and the lens system described in the above embodiments. The photosensitive element is disposed on the image side of the lens system.

An electronic device includes a housing and the imaging module described in the above embodiment, and the imaging module is mounted on the housing.

The details of one or more embodiments of the present disclosure are set forth in the accompanying drawings and description below. Other features, purposes and advantages of the present disclosure will become apparent from the description, the accompanying drawings, and the claims.

### BRIEF DESCRIPTION OF THE DRAWINGS

To better describe and illustrate embodiments or examples of the disclosure disclosed herein, reference may be made to one or more accompanying drawings. The additional details or examples used to describe the accompanying drawings should not be construed as limiting the scope of any of the disclosed disclosure, the presently described embodiments or examples, and the presently understood preferred mode of the disclosure.

FIG. 1 shows a schematic top view of a lens system according to Embodiment 1 of the present disclosure.

FIG. 2 shows a schematic front view of the lens system according to Embodiment 1.

FIG. 3 shows a schematic view of a lens group according to Embodiment 1.

FIG. 4 shows graphs of longitudinal spherical aberration, astigmatism, and distortion of the lens system according to Embodiment 1, respectively.

FIG. 5 shows a schematic top view of a lens system according to Embodiment 2 of the present disclosure.

FIG. 6 shows a schematic front view of the lens system according to Embodiment 2.

FIG. 7 shows a schematic view of a lens group according to Embodiment 2.

FIG. 8 shows graphs of longitudinal spherical aberration, astigmatism, and distortion of the lens system according to Embodiment 2, respectively.

FIG. 9 shows a schematic top view of a lens system according to Embodiment 3 of the present disclosure.

FIG. 10 shows a schematic front view of the lens system according to Embodiment 3.

FIG. 11 shows a schematic view of a lens group according to Embodiment 3.

FIG. 12 shows graphs of longitudinal spherical aberration, astigmatism, and distortion of the lens system according to Embodiment 3, respectively.

FIG. 13 shows a schematic top view of a lens system according to Embodiment 4 of the present disclosure.

FIG. 14 shows a schematic front view of the lens system according to Embodiment 4.

FIG. 15 shows a schematic view of a lens group according to Embodiment 4.

FIG. 16 shows graphs of longitudinal spherical aberration, astigmatism, and distortion of the lens system according to Embodiment 4, respectively.

FIG. 17 shows a schematic top view of a lens system according to Embodiment 5 of the present disclosure.

FIG. 18 shows a schematic front view of the lens system according to Embodiment 5.

FIG. 19 shows a schematic view of a lens group according to Embodiment 5.

FIG. 20 shows graphs of longitudinal spherical aberration, astigmatism, and distortion of the lens system according to Embodiment 5, respectively.

FIG. 21 shows a schematic top view of a lens system according to Embodiment 6 of the present disclosure.

FIG. 22 shows a schematic front view of the lens system according to Embodiment 6.

FIG. 23 shows a schematic view of a lens group according to Embodiment 6.

FIG. 24 shows graphs of longitudinal spherical aberration, astigmatism, and distortion of the lens system according to Embodiment 6, respectively.

FIG. 25 shows a schematic top view of a lens system according to Embodiment 7 of the present disclosure.

FIG. 26 shows a schematic front view of the lens system according to Embodiment 7.

FIG. 27 shows a schematic view of a lens group according to Embodiment 7.

FIG. 28 shows graphs of longitudinal spherical aberration, astigmatism, and distortion of the lens system according to Embodiment 7, respectively.

FIG. 29 shows a schematic top view of a lens system according to Embodiment 8 of the present disclosure.

FIG. 30 shows a schematic front view of the lens system according to Embodiment 8.

FIG. 31 shows a schematic view of a lens group according to Embodiment 8.

FIG. 32 shows graphs of longitudinal spherical aberration, astigmatism, and distortion of the lens system according to Embodiment 8, respectively.

FIG. 33 shows a schematic top view of a lens system according to Embodiment 9 of the present disclosure.

FIG. 34 shows a schematic front view of the lens system according to Embodiment 9.

FIG. 35 shows a schematic view of a lens group according to Embodiment 9.

FIG. 36 shows graphs of longitudinal spherical aberration, astigmatism, and distortion of the lens system according to Embodiment 9, respectively.

FIG. 37 shows a schematic top view of a lens system according to Embodiment 10 of the present disclosure.

FIG. 38 shows a schematic front view of the lens system according to Embodiment 10.

FIG. 39 shows a schematic view of a lens group according to Embodiment 10.

FIG. 40 shows graphs of longitudinal spherical aberration, astigmatism, and distortion of the lens system according to Embodiment 10, respectively.

FIG. 41 shows a schematic top view of a lens system according to Embodiment 11 of the present disclosure.

FIG. 42 shows a schematic front view of the lens system according to Embodiment 11.

FIG. 43 shows a schematic view of a lens group according to Embodiment 11.

FIG. 44 shows graphs of longitudinal spherical aberration, astigmatism, and distortion of the lens system according to Embodiment 11, respectively.

FIG. 45 shows a schematic view of an imaging module according to an embodiment of the present disclosure.

### DETAILED DESCRIPTION OF THE EMBODIMENTS

To make the purposes, technical solutions and advantages of the present disclosure to be more apparent and understandable, reference will be made to the accompanying drawings and embodiments to describe the present disclosure in detail below. It should be understood that the specific embodiments described herein are only used to explain the present disclosure and not intended to limit the present disclosure.

It should be understood that when an element is defined as “disposed” on another element, it is either directly on an element or indirectly on an element with a mediating element. When an element is considered to be “connected” to another element, it may be directly connected to another element or there may be an intermediate element between them at the same time. The terms “vertical”, “horizontal”, “left”, “right”, and the like used herein are for illustrative purposes only and are not intended to be the only embodiment.

All technical and scientific terms used herein have the same meaning as commonly understood by one of ordinary skill in the art to which this disclosure applies, unless otherwise defined. The terms used in the specification of present disclosure herein are for the purpose of describing specific embodiments only and are not intended to limit the present disclosure. The term “and/or” used herein includes any and all combinations of one or more of the associated listed items.

In this specification, expressions such as first, second, third, and the like, are merely used to distinguish one feature from another feature, and do not indicate any limitations on the features. Therefore, without departing from the teachings of the present disclosure, the first lens discussed below may also be referred to as a second lens or a third lens. To facilitate the description, the shapes of the spherical surfaces or aspherical surfaces shown in the drawings are shown by way of example. That is, the shapes of the spherical surfaces or the aspherical surfaces are not limited to the shapes of the spherical surfaces or the aspherical surfaces shown in the drawings. The accompanying drawings are only examples and are not drawn strictly to scale.

In this specification, a space on a side where an object is located relative to an optical element is referred to as an object side of the optical element, and correspondingly, a space on a side where an image imaged by the object is located relative to the optical element is referred to as an image side of the optical element. A surface of each lens closest to the object is called an object side surface, and a surface of each lens closest to the imaging plane is called an image side surface.

In addition, in the description hereinafter, if a surface of the lens is convex and the convex position is not defined, it means that this surface of the lens is convex at least at the paraxial area. If a surface of the lens is concave and the concave position is not defined, it means that this surface of the lens is concave at least at the paraxial area. The paraxial area here refers to an area near the optical axis.

The conventional periscopic lens usually uses one or two reflective prisms to realize the folding of the optical path. However, if the focal length of this type of lens is made longer, it is easy to increase the thickness of the mobile phone or to cause the total length of the lens itself become longer, which affects the arrangement of other elements of the mobile phone. Therefore, the focal length of the conventional periscopic lens is usually not long, and it is difficult to meet the user's higher demand for long-distance zoom shooting.

The defects of the above solutions are results obtained by the inventors through practice and careful research. Therefore, the discovery process of the above problems and the solutions proposed in the embodiments of the present disclosure for the above problems below should be regarded as the inventors' contributions to the present disclosure during the process of the present disclosure.

A lens system according to the embodiments of the present disclosure includes a plurality of optical elements arranged along a folded optical axis thereof. The above plurality of optical elements include, sequentially arranged from an object side to an image side, a first optical path folding element, a lens group, a second optical path folding element, and a third optical path folding element.

The first optical path folding element is located on a first part of the folded optical axis, and the first optical path folding element is configured to direct light from the first part of the folded optical axis to a second part of the folded optical axis. The lens group is located on the second part of the folded optical axis. The second optical path folding element is configured to direct light from the second part of the folded optical axis to a third part of the folded optical axis. The third optical path folding element is configured to direct light from the third part of the folded optical axis to a fourth part of the folded optical axis. Finally, the light rays are received by a photosensitive element located on the fourth part of the folded optical axis.

The second part, the third part, and the fourth part of the folded optical axis are located in one same plane, and this plane is perpendicular to the first part of the folded optical axis.

The above lens system can allow the above plurality of optical elements to be arranged along a transverse direction of the electronic product, instead of being arranged along a thickness direction of the electronic equipment, so that the lens can achieve a long focal length while ensuring that the electronic product is light and thin. In addition, by folding the optical axis of the lens system, the transverse total length of the lens system can be effectively shortened, thereby saving the transverse space of the electronic product and facilitating the arrangement of other elements in the electronic product.

Specifically, the optical folding element may be a prism. The prism includes a light incident surface, a reflective surface, and a light emergent surface. Light rays are incident from the light incident surface, are totally reflected on the reflective surface, and then are emitted from the light emergent surface, thereby completing the folding of the optical path. Further, the prism may be a right-angle prism, so that the light rays can be turned 90°, which is convenient for adjusting the folding path of the light rays in the lens system.

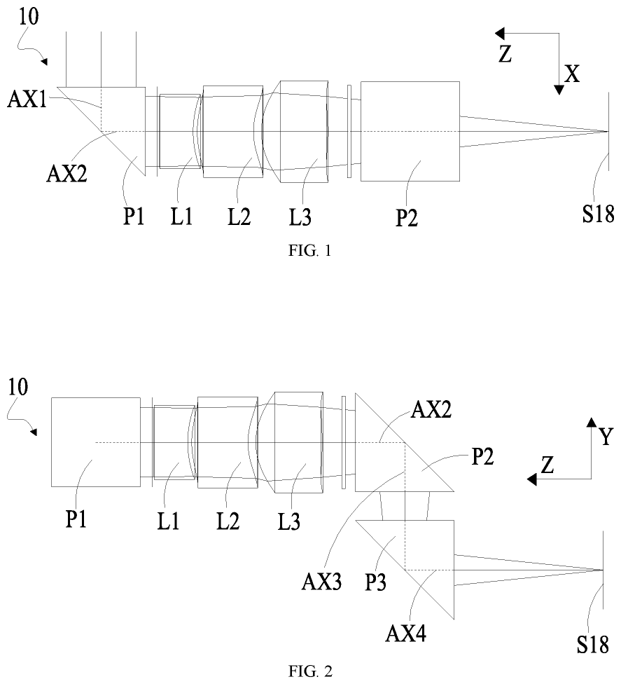

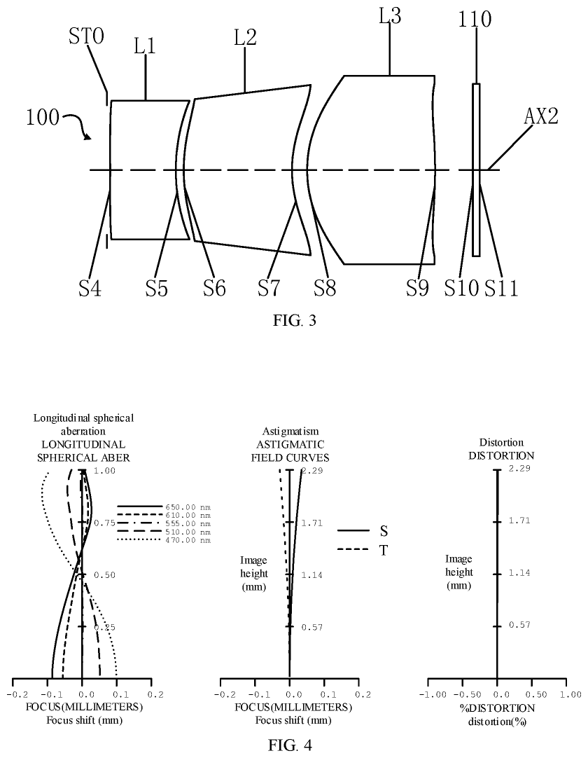

Taking a lens system 10 shown in FIGS. 1 to 3 as an example, the lens system 10 includes a first right-angle prism P1, a lens group 100, a second right-angle prism P2, and a third right-angle prism P3 arranged along its folded optical axis. A light incident surface S1 of the first right-angle prism P1, a light incident surface S12 of the second right-angle prism P2, and a light incident surface S15 of the third right-angle prism P3 are perpendicular to each other. A light emergent surface S3 of the first right-angle prism P1 is perpendicular to a light emergent surface S14 of the second right-angle prism P2, and the light emergent surface S3 of the first right-angle prism P1 is parallel to a light emergent surface S17 of the third right-angle prism P3, so that a first part AX1 (that is, the X direction in the figures) of the folded optical axis is perpendicular to a plane where a second part AX2, a third part AX3, and a fourth part AX4 of the folded optical axis are located. Therefore, after being incident along the optical axis AX1, light rays can be sequentially re-directed to the optical axis AX2, the optical axis AX3, and the optical axis AX4, so as to achieve a long focal length. In addition, the third right-angle prism P3 can also be prevented from being arranged along the thickness direction (that is, the direction of the optical axis AX1 in FIG. 1) of the electronic product, so as to meet the development trend of becoming lighter and thinner for the electronic products.

In an exemplary embodiment, the lens group includes, sequentially arranged from the object side to the image side along the second part of the folded optical axis, a first lens having a refractive power, a second lens having a refractive power, and a third lens having a refractive power. An object side surface and/or an image side surface of at least one lens of the first lens to the third lens are aspherical, and at least one surface of the object side surface and the image side surface of the at least one lens has at least one inflection point.

By arranging an appropriate number of lenses in the lens group and reasonably distributing the refractive power, surface shape, and effective focal length of each of the lenses, the imaging resolution capability of the lens system can be enhanced and aberrations can be effectively corrected. In addition, by configuring the surface of the lens as an aspherical surface, the flexibility of lens design can be improved, so as to further correct the aberrations. Moreover, the inflection point can further be arranged on the aspherical surface, so that the incident angle of the chief ray can be better matched with the photosensitive element, thereby improving the imaging quality of the lens system.

In some other embodiments, the object side surfaces and the image side surfaces of the lenses of the lens group may also be all spherical surfaces. It should be noted that the above embodiments are merely examples of some embodiments of the present disclosure. In some embodiments, the surfaces of the lenses in the lens group may be any combination of aspherical surface or spherical surface.

Further, an optical stop is further provided in the lens group, and the optical stop is arranged on the object side of the lens group, that is, between the first optical path folding element and the first lens, so as to better control the size of the incident light beam and improve the imaging quality of the lens system. Specifically, the optical stop includes an aperture stop and a field stop. Preferably, the optical stop is an aperture stop. The aperture stop can be located on a surface (for example, the object side surface and the image side surface) of the lens, and form a functional relationship with the lens. For example, an aperture stop can be formed on the surface by coating a light-blocking coating layer on a surface of the lens; or, a surface of the lens is fixedly clamped by a clamping piece, and the structure of the clamping piece located on the surface can limit a width of an imaging light beam of an on-axis object point, thereby forming an aperture stop on the surface.

When the above described lens system is used for imaging, light rays emitted or reflected by a subject enter the lens system from the object side, and sequentially pass through the first optical path folding element, the first lens, the second lens, the third lens, the second optical path folding element, and the third optical path folding element, and finally converge onto the imaging plane.

In an exemplary embodiment, the lens system satisfies the following relation: 3 mm<f/FNO<12 mm; where, f represents an effective focal length of the lens system, and FNO represents an f-number of the lens system. f/FNO may be 3.5 mm, 4 mm, 5 mm, 5.5 mm, 6 mm, 6.5 mm, 7 mm, 7.5 mm, 8 mm, 8.5 mm, 9 mm, 9.5 mm, 10 mm, 10.5 mm, or 11 mm Under the condition that the above relation is satisfied, an entrance pupil diameter of the lens system can be effectively adjusted, thereby effectively limiting the overall width of the lens system, which is conducive to the miniaturization of the lens group and saves the space of the electronic product. When f/FNO is less than or equal to 3, the entrance pupil diameter of the system is reduced, and the amount of light entering is reduced, which will easily lead to darkening of the image and reduced clarity of the image, which is not conducive to imaging. When f/FNO is greater than or equal to 12, the entrance pupil diameter of the system is relatively large, which is not conducive to reducing the width of the system, making the system occupy a larger space.

In an exemplary embodiment, the lens system satisfies the following relation: HFOV/TTL>0.1 degrees/mm; where, HFOV represents a half field of view of the lens system in a diagonal direction, and TTL represents a distance on the optical axis from an object side surface of the first lens to the imaging plane of the lens system. HFOV/TTL may be 0.15, 0.17, 0.21, 0.22, 0.23, 0.24, 0.25, 0.26, 0.27, 0.28, 0.29, 0.3 or 0.35, in a unit of degrees/mm Under the condition that HFOV/TTL satisfies the above relation, the image height of the imaged image and the total length of the lens system can be reasonably allocated, which is conducive to shortening the total length of the lens system and achieving the miniaturization. When HFOV/TTL is less than or equal to 0.1, the total length of the system is larger and the field of view is smaller, which tends to degrade the image quality.

In an exemplary embodiment, the lens system satisfies the following relation: TTL/f<1.2; where, TTL represents a distance on the optical axis from the object side surface of the first lens to the imaging plane of the lens system, and f represents the effective focal length of the lens system. TTL/f may be 0.4, 0.45, 0.5, 0.55, 0.6, 0.65, 0.7, 0.75, 0.8, 0.85, 0.9, 0.95, or 1.0. Under the condition that the above relation is satisfied, the effective focal length of the lens system and the total length of the lens system can be reasonably allocated, so that not only the miniaturization of the lens system can be realized, but also the light rays can be better focused on the imaging plane, and the imaging quality can be improved. When TTL/f is greater than or equal to 1.2, the total length of the system is longer, which is not conducive to miniaturization.

In an exemplary embodiment, the lens system satisfies the following relation: f>15 mm; where f is the effective focal length of the lens system. f may be 20 mm, 23 mm, 25 mm, 27 mm, 29 mm, 31 mm, 33 mm, 35 mm, 37 mm, or 40 mm Under the condition that the above relation is satisfied, the lens system can have a characteristic of a long focal length, so that clear imaging of a distant object can be realized. When f is less than or equal to 15 mm, the focal length is relatively short, and the long-distance shooting capability of the lens system is not high.

In an exemplary embodiment, the lens system satisfies the following relation: CT12/CT23<3; where, CT12 represents a distance on the optical axis from an image side surface of the first lens to an object side surface of the second lens, and CT23 represents a distance on the optical axis from an image side surface of the second lens to an object side surface of the third lens. CT12/CT23 may be 0.02, 0.03, 0.06, 0.09, 0.1, 0.2, 0.3, 0.4, 0.5, 1.0, 2.5, 2.9 or 2.95. Under the condition that the above relation is satisfied, it is conducive to correcting the aberration of the lens system and control the degree of the curvature of field of the lens system, thereby improving the imaging quality. When CT12/CT23 is greater than or equal to 3, a distance between the first lens and the second lens is relatively far, and the second lens and the third lens are relatively close to each other, which is not conducive to correcting the aberrations of the system and controlling the curvature of field, and tends to affect the imaging quality.

In an exemplary embodiment, the lens system satisfies the following relation: 2.2<FNO<6.8; where, FNO represents the f-number of the lens system. FNO may be 2.3, 2.5, 3, 3.3, 3.6, 3.9, 4.5, 4.9, 5.2, 5.5, 6, or 6.5. Under the condition that the above relation is satisfied, the amount of light passing through the lens system can be increased, thereby reducing the aberration of the edge field of view of the system, and in addition, the lens system can also obtain clear and detailed information of the subject even in a relatively dark environment or in the case of insufficient light rays, thereby improving the image quality. When FNO is less than or equal to 2.2, it is easy to cause the depth of field of the system to be small, which is not conducive to the clear presentation of the details of the object.

In an exemplary embodiment, the lens system satisfies the following relation: D32/ImgH<1.3; where D32 represents an effective half clear aperture of the third lens, and ImgH represents half of a diagonal length of an effective pixel area on the imaging plane of the lens system. D32/ImgH may be 0.5, 0.9, 1, 1.05, 1.1, 1.12, 1.14, 1.16, 1.18, 1.2, 1.25, 1.28, or 1.29. Under the condition that the above relation is satisfied, the size of the lens group can be effectively limited, which is conducive to realize the ultra-thinness of the lens system, and meets the development needs of light and thin electronic products. When D32/ImgH is greater than or equal to 1.3, the effective half clear aperture of the third lens is relatively large, which does not meet the application needs of light and thin electronic products.

In an exemplary embodiment, the lenses in the lens group may be all made of glass or all made of plastic. The plastic lenses can reduce the weight of the lens system and reduce the production cost, while the glass lenses can make the lens system have relatively good temperature tolerance characteristics and excellent optical performance. Further, when the lens system is applied to portable electronic equipment such as mobile phones and tablets, the lenses are preferably made of plastic. It should be noted that the lenses in the lens group can also be made of any combination of glass and plastic, and not necessarily be all made of glass or all made of plastic.

In an exemplary embodiment, the lens group further includes an infrared filter. The infrared filter is arranged between the third lens and the second optical path folding element to filter incident light rays, specifically to isolate infrared light and prevent infrared light from being absorbed by the photosensitive element, thereby avoiding infrared light from affecting the color and clarity of normal images, and improving the imaging quality of the lens system.

The lens group of the above described embodiments of the present disclosure may use a plurality of lenses, for example, three lenses as described above. By reasonably distributing the focal lengths, refractive powers, surface shapes, thicknesses of the lenses, and on-axis distances among the lenses, it is possible to ensure that the above lens system has a long focal length, while the system has relatively small total length and is relatively light in weight, and has relatively high imaging quality, which can better meet the application needs of lightweight electronic equipment such as mobile phones, tablets, and the like. However, it should be appreciated by those skilled in the art that without departing from the technical solution claimed in the present disclosure, the number of lenses constituting the lens group can be changed to obtain the various results and advantages described in this specification.

Specific embodiments of the lens system applicable to the above described embodiments will be further described below with reference to the accompanying drawings.

### Embodiment 1

A lens system 10 of Embodiment 1 of the present disclosure will be described below with reference to FIGS. 1 to 4.

As shown in FIGS. 1 to 3, the lens system 10 includes, sequentially arranged from an object side to an image side along a folded optical axis, a first right-angle prism P1, a first lens L1, a second lens L2, a third lens L3, a second right-angle prism P2, a third right-angle prism P3, and an imaging plane S18. The folded optical axis includes a first part AX1, a second part AX2, a third part AX3, and a fourth part AX4. The first lens L1, the second lens L2, and the third lens L3 are located on the optical axis AX2. Further, Y-Z coordinate axes are provided in FIG. 1, and Y-X coordinate axes are provided in FIG. 2, where, the optical axis AX1 is parallel to the X axis, the optical axis AX3 is parallel to the Y axis, and the optical axis AX2 and the optical axis AX4 are parallel to the Z axis.

The first right-angle prism P1 has a light incident surface S1, a reflective surface S2, and a light emergent surface S3.

The first lens L1 has a negative refractive power, and an object side surface S4 and an image side surface S5 thereof are both aspherical. The object side surface S4 is concave at the optical axis and is convex at its circumference, and the image side surface S5 is concave at the optical axis and is concave at its circumference. The second lens L2 has a positive refractive power, and an object side surface S6 and an image side surface S7 thereof are both aspherical. The object side surface S6 is convex at the optical axis and is concave at its circumference, and the image side surface S7 is concave at the optical axis and is convex at its circumference. The third lens L3 has a positive refractive power, and an object side surface S8 and an image side surface S9 thereof are both aspherical. The object side surface S8 is convex at the optical axis and is convex at its circumference, and the image side surface S9 is convex at the optical axis and is concave at its circumference.

The second right-angle prism P2 has a light incident surface S12, a reflective surface S13, and a light emergent surface S14.

The third right-angle prism P3 has a light incident surface S15, a reflective surface S16, and a light emergent surface S17.

Light rays can be folded by the reflective surfaces of the right-angle prisms by 90° and then are emitted, so as to achieve a long focal length while shortening the transverse total length of the system. In this embodiment, the light rays are incident along the optical axis AX1 (that is, the X-axis direction), and then are reflected by the reflective surface S2 of the first right-angle prism P1 to be folded by 90°, and directed to the optical axis AX2 (that is, the Z-axis direction) and projected to the lens group 100. After being emitted from the lens group 100, the light rays are further reflected by the reflective surface S13 of the second right-angle prism P2 to be folded by 90°, and directed to the optical axis AX3 (that is, the Y-axis direction). Finally, the light rays are reflected by the reflective surface S16 of the third right-angle prism P3 to be folded by 90°, and directed to the optical axis AX4 (that is, the Z-axis direction), so as to be received by a photosensitive element (not shown in the figure) disposed on the optical axis AX4.

The object side surfaces and the image side surfaces of the first lens L1 to the third lens L3 are configured to be aspherical, which is conducive to correcting aberrations and solving the problem of distortion of the image plane, and can also enable the lens to achieve good optical imaging effects even when the lenses are small, thin, and flat, thereby enabling the lens system 10 to have a characteristic of miniaturization.

The first lens L1 to the third lens L3 are all made of plastic, so as to reduce the weight of the lens system 10 and reduce the production cost. An optical stop STO is further disposed between the first right-angle prism P1 and the first lens L1 to limit the size of the incident light beam and further improve the imaging quality of the lens system 10. The lens system 10 further includes a filter 110 disposed on an image side of the third lens L3 and having an object side surface S10 and an image side surface S11. Light from the object OBJ sequentially passes through the respective surfaces S1 to S17 and is finally imaged on the imaging plane S18. Further, the filter 110 is an infrared filter, which is configured to filter infrared light rays from external light rays incident on the lens system 10 to avoid color distortion of the image. Specifically, the filter 110 is made of glass.

Table 1 shows the surface type, radius of curvature, thickness, material, refractive index, Abbe number (that is, dispersion coefficient) of each of the optical elements and effective focal lengths of lenses of the lens system 10 according to Embodiment 1, where the units of the radius of curvature, the thickness, the effective focal length of the lens, Y-half aperture (effective half clear aperture in the Y-direction of the lens), and X-half aperture (effective half clear aperture in the X-direction of the lens) are all millimeters (mm) In addition, taking the first right-angle prism P1 as an example, it is default that a direction facing inward the page and perpendicular to the page is the positive direction of the optical axis AX1, and a direction facing outward the page and perpendicular to the page is the negative direction of the optical axis AX1. Taking the first lens L1 as an example, the first value of the first lens L1 in the “thickness” parameter column is a thickness of the lens on the optical axis AX2, and the second value therein is a distance on the optical axis AX2 from an image side surface of the lens to an object side surface of a lens that is subsequent in a direction towards the image side. It is default that a direction from the object side surface S4 of the first lens L1 to the image side surface S9 of the third lens L3 is the positive direction of the optical axis AX2. The value of the optical stop STO in the “thickness” parameter column is a distance on the optical axis AX2 from the optical stop STO to a vertex of the object side surface of the subsequent lens (the vertex refers to an intersection of the lens and the optical axis). When this value is negative, it means that the optical stop STO is disposed on the right side of the vertex of the object side surface of the lens, and when the thickness of the optical stop STO is positive, the optical stop is on the left side of the vertex of the object side surface of the lens Taking the second right-angle prism P2 and the third right-angle prism P3 as an example, a direction from the surface S14 to the surface S15 is the negative direction of the optical axis AX3 Taking the third right-angle prism P3 as an example, a direction from the surface S17 to the imaging plane S18 is the positive direction of the optical axis AX4.

TABLE 1
Embodiment 1
f = 20 mm, FNO = 4.9, HFOV = 6.52°, TTL = 18.93 mm

| Surface | Surface | Surface | Radius of | Thick- | | Refractive | Abbe | Focal | Refraction | Y-half | X-half |
|---|---|---|---|---|---|---|---|---|---|---|---|
| number | name | type | curvature | ness | Material | index | number | length | mode | aperture | aperture |
| OBJ | Object | Spherical | Infinite | Infinite | | | | | Refraction | | |
| | plane | | | | | | | | | | |
| S1 | First right- | Spherical | Infinite | −2.600 | Glass | 1.518 | 64.166 | | Refraction | 2.600 | 2.600 |
| S2 | angle prism | Spherical | Infinite | 2.600 | | | | | Reflection | 2.600 | 3.677 |
| S3 | | Spherical | Infinite | 0.700 | | | | | Refraction | 2.600 | 2.600 |
| STO | Optical stop | Spherical | Infinite | 0.100 | | | | | Refraction | 2.041 | 2.041 |
| S4 | First lens | Aspherical | −142.561 | 2.000 | Plastic | 1.546 | 56.114 | −10.283 | Refraction | 2.055 | 2.055 |
| S5 | | Aspherical | 5.873 | 0.241 | | | | | Refraction | 2.178 | 2.178 |
| S6 | Second lens | Aspherical | 5.325 | 3.303 | Plastic | 1.644 | 23.517 | 999.997 | Refraction | 2.231 | 2.231 |
| S7 | | Aspherical | 4.065 | 0.461 | | | | | Refraction | 2.675 | 2.675 |
| S8 | Third lens | Aspherical | 3.997 | 3.900 | Plastic | 1.546 | 56.114 | 6.237 | Refraction | 2.961 | 2.961 |
| S9 | | Aspherical | −15.065 | 1.149 | | | | | Refraction | 2.737 | 2.737 |
| S10 | Infrared | Spherical | Infinite | 0.210 | Glass | 1.518 | 64.166 | | Refraction | 2.710 | 2.710 |
| S11 | filter | Spherical | Infinite | 0.590 | | | | | Refraction | 2.707 | 2.707 |
| S12 | Second | Spherical | Infinite | 2.900 | Glass | 1.518 | 64.166 | | Refraction | 2.900 | 2.900 |
| S13 | right-angle | Spherical | Infinite | −2.900 | | | | | Reflection | 4.101 | 2.900 |
| S14 | prism | Spherical | Infinite | −1.680 | | | | | Refraction | 2.900 | 2.900 |
| S15 | Third right- | Spherical | Infinite | −2.900 | Glass | 1.518 | 64.166 | | Refraction | 2.900 | 2.900 |
| S16 | angle prism | Spherical | Infinite | 2.900 | | | | | Reflection | 4.101 | 2.900 |
| S17 | | Spherical | Infinite | 8.759 | | | | | Refraction | 2.900 | 2.900 |
| S18 | Imaging | Spherical | Infinite | 0.000 | | | | | Refraction | 2.285 | 2.285 |
| | plane | | | | | | | | | | |

A surface shape of aspherical surface of each lens is defined by the following equation:

$$x = \frac{{ch}^{2}}{1 + \sqrt{1 - ( k + 1 ) {c}^{2} {h}^{2}}} + Σ {Aih}^{i} \qquad ( 1 )$$

Where, x is a distance vector height of the aspherical surface from the vertex of the aspherical surface when the aspherical surface is at a position with a height of h along the optical axis direction; c is a paraxial curvature of the aspherical surface, c=1/R (that is, the paraxial curvature c is a reciprocal of the radius of curvature R shown in Table 1); k is a conic coefficient; and Ai is an i-th order coefficient of the aspherical surface. Table 2 below shows the high-order term coefficients A4, A6, A8, A10, A12, A14, A16, A18, and A20 that can be used for the lens aspherical surfaces S4 to S9 in Embodiment 1.

TABLE 2
Embodiment 1
Aspheric coefficient

| Surface | | | | | | |
|---|---|---|---|---|---|---|
| number | S4 | S5 | S6 | S7 | S8 | S9 |
| K | 0.0000E+00 | 0.0000E+00 | 0.0000E+00 | 0.0000E+00 | 0.0000E+00 | 0.0000E+00 |
| A4 | −2.9700E−03 | −7.7000E−04 | 4.9400E−03 | 2.7800E−03 | −2.5300E−03 | −2.7200E−03 |
| A6 | 1.9000E−04 | 6.6000E−04 | 5.9000E−04 | 1.3400E−03 | 1.0000E−03 | −1.8000E−04 |
| A8 | −1.0000E−05 | −1.6000E−04 | −1.2000E−04 | −1.1000E−04 | −8.0000E−05 | −1.0000E−05 |
| A10 | 0.0000E+00 | 1.0000E−05 | 1.0000E−05 | 0.0000E+00 | 0.0000E+00 | 0.0000E+00 |
| A12 | 0.0000E+00 | 0.0000E+00 | 0.0000E+00 | 0.0000E+00 | 0.0000E+00 | 0.0000E+00 |
| A14 | 0.0000E+00 | 0.0000E+00 | 0.0000E+00 | 0.0000E+00 | 0.0000E+00 | 0.0000E+00 |
| A16 | 0.0000E+00 | 0.0000E+00 | 0.0000E+00 | 0.0000E+00 | 0.0000E+00 | 0.0000E+00 |
| A18 | 0.0000E+00 | 0.0000E+00 | 0.0000E+00 | 0.0000E+00 | 0.0000E+00 | 0.0000E+00 |
| A20 | 0.0000E+00 | 0.0000E+00 | 0.0000E+00 | 0.0000E+00 | 0.0000E+00 | 0.0000E+00 |

The ImgH which is half of a diagonal length of an effective pixel area on the imaging plane S18 of the lens system 10 of this embodiment is 2.285 mm. Combining the data in Table 1 and Table 2, it can be seen that the lens system 10 in Embodiment 1 satisfies the following relations.

f/FNO=4.082 mm, where, f represents an effective focal length of the lens system 10, and FNO represents an f-number of the lens system 10.

HFOV/TTL=0.344 degrees/mm, where, HFOV represents a half field of view of the lens system 10 in a diagonal direction, and TTL represents a distance on the folded optical axis from the object side surface S4 of the first lens L1 to the imaging plane S18 of the lens system 10.

TTL/f=0.947, where, TTL represents a distance on the optical axis from the object side surface S4 of the first lens L1 to the imaging plane S18 of the lens system 10, and f represents the effective focal length of the lens system 10.

f=20 mm, where, f represents the effective focal length of the lens system 10.

CT12/CT23=0.522, where, CT12 represents a distance on the optical axis AX2 from the image side surface S5 of the first lens L1 to the object side surface S6 of the second lens L2, and CT23 represents a distance on the optical axis AX2 from the image side surface S7 of the second lens L2 to the object side surface S8 of the third lens L3.

FNO=4.9, where, FNO represents the f-number of the lens system 10.

D32/ImgH=1.198, where, D32 represents an effective half clear aperture of the third lens L3, and ImgH represents half of the diagonal length of the effective pixel area on the imaging plane S18 of the lens system 10.

FIG. 4 shows graphs of longitudinal spherical aberration, astigmatism, and distortion of the lens system 10 according to Embodiment 1, respectively. The reference wavelength of the lens system 10 is 555 nm. The graph of longitudinal spherical aberration shows the deviation of the convergent focus of light rays with wavelengths of 470 nm, 510 nm, 555 nm, 610 nm, and 650 nm after passing through the lens system 10. The graph of astigmatism shows the curvature of meridian image plane and the curvature of sagittal image plane of the lens system 10. The graph of distortion shows the distortion of the lens system 10 with different image heights. According to FIG. 4, it can be seen that the lens system 10 provided in Embodiment 1 can achieve good imaging quality.

### Embodiment 2

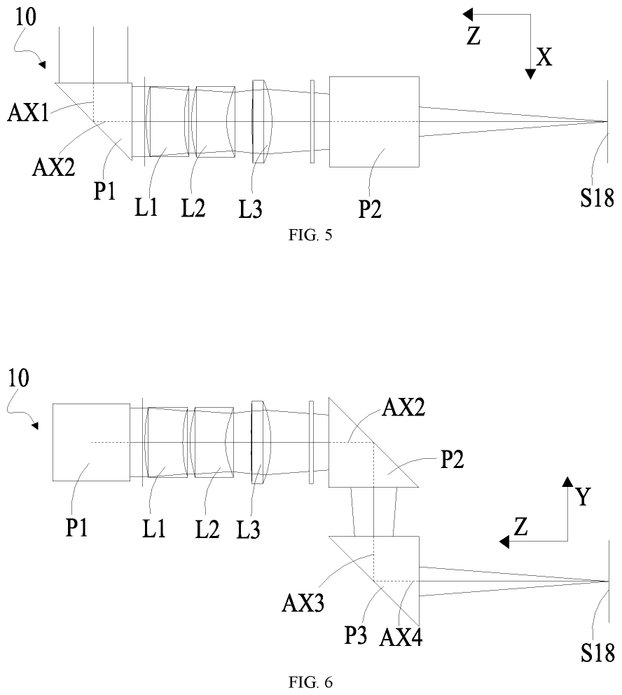

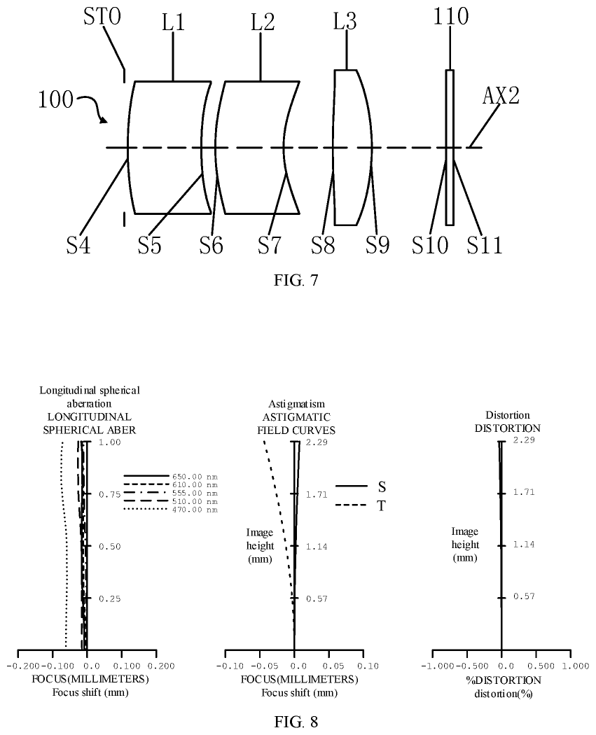

A lens system 10 of Embodiment 2 of the present disclosure will be described below with reference to FIGS. 5 to 8. In this embodiment, for the sake of brevity, some descriptions similar to those in Embodiment 1 will be omitted.

As shown in FIGS. 5 to 7, the lens system 10 includes, sequentially arranged from an object side to an image side along an optical axis, a first right-angle prism P1, a first lens L1, a second lens L2, a third lens L3, a second right-angle prism P2, a third right-angle prism P3, and an imaging plane S18. The folded optical axis includes a first part AX1, a second part AX2, a third part AX3, and a fourth part AX4. The first lens L1, the second lens L2, and the third lens L3 are located on the optical axis AX2.

The first right-angle prism P1 has a light incident surface S1, a reflective surface S2, and a light emergent surface S3.

The first lens L1 has a negative refractive power, and an object side surface S4 and an image side surface S5 thereof are both aspherical. The object side surface S4 is convex at the optical axis and is convex at its circumference, and the image side surface S5 is concave at the optical axis and is concave at its circumference. The second lens L2 has a negative refractive power, and an object side surface S6 and an image side surface S7 thereof are both aspherical. The object side surface S6 is convex at the optical axis and is convex at its circumference, and the image side surface S7 is concave at the optical axis and is convex at its circumference. The third lens L3 has a positive refractive power, and an object side surface S8 and an image side surface S9 thereof are both aspherical. The object side surface S8 is convex at the optical axis and is concave at its circumference, and the image side surface S9 is convex at the optical axis and is convex at its circumference.

The second right-angle prism P2 has a light incident surface S12, a reflective surface S13, and a light emergent surface S14.

The third right-angle prism P3 has a light incident surface S15, a reflective surface S16, and a light emergent surface S17.

The object side surfaces and the image side surfaces of the first lens L1 to the third lens L3 are all configured to be aspherical. The first lens L1 to the third lens L3 are all made of plastic. An optical stop STO is further disposed between the first right-angle prism P1 and the first lens L1. The lens system 10 further includes an infrared filter 110 disposed on an image side of the third lens L3 and having an object side surface S10 and an image side surface S11.

Table 3 shows the surface type, radius of curvature, thickness, material, refractive index, Abbe number (that is, dispersion coefficient), effective focal length, Y-half aperture, and X-half aperture of each of the lenses of the lens system 10 according to Embodiment 2, where the units of the radius of curvature, the thickness, the effective focal length of each of the lenses, the Y-half aperture, and the X-half aperture are all millimeters (mm) Table 4 shows the high-order term coefficients that can be used for the lens aspherical surfaces S4 to S9 in Embodiment 2, where the surface shape of the aspherical surface can be defined by the equation (1) provided in Embodiment 1. Table 5 shows values of relevant parameters of the lens system 10 given in Embodiment 2.

TABLE 3
Embodiment 2
f = 25 mm, FNO = 6.51, HFOV = 5.22°, TTL = 18.01 mm

| Surface | Surface | Surface | Radius of | Thick- | | Refractive | Abbe | Focal | Refraction | Y-half | X-half |
|---|---|---|---|---|---|---|---|---|---|---|---|
| number | name | type | curvature | ness | Material | index | number | length | mode | aperture | aperture |
| OBJ | Object | Spherical | Infinite | Infinite | | | | | Refraction | | |
| | plane | | | | | | | | | | |
| S1 | First right- | Spherical | Infinite | −2.150 | Glass | 1.518 | 64.166 | | Refraction | 2.150 | 2.150 |
| S2 | angle prism | Spherical | Infinite | 2.150 | | | | | Reflection | 2.150 | 3.041 |
| S3 | | Spherical | Infinite | 0.700 | | | | | Refraction | 2.150 | 2.150 |
| STO | Optical | Spherical | Infinite | 0.100 | | | | | Refraction | 1.920 | 1.920 |
| | stop | | | | | | | | | | |
| S4 | First lens | Aspherical | 10.572 | 2.112 | Plastic | 1.546 | 56.114 | −1000.001 | Refraction | 1.948 | 1.948 |
| S5 | | Aspherical | 9.640 | 0.399 | | | | | Refraction | 1.885 | 1.885 |
| S6 | Second | Aspherical | 5.954 | 1.960 | Plastic | 1.644 | 23.517 | −17.016 | Refraction | 1.953 | 1.953 |
| S7 | lens | Aspherical | 3.360 | 1.415 | | | | | Refraction | 1.950 | 1.950 |
| S8 | Third lens | Aspherical | 25.721 | 1.117 | Plastic | 1.546 | 56.114 | 9.625 | Refraction | 2.186 | 2.186 |
| S9 | | Aspherical | −6.502 | 2.134 | | | | | Refraction | 2.284 | 2.284 |
| S10 | Infrared | Spherical | Infinite | 0.210 | Glass | 1.518 | 64.166 | | Refraction | 2.284 | 2.284 |
| S11 | filter | Spherical | Infinite | 0.853 | | | | | Refraction | 2.284 | 2.284 |
| S12 | Second | Spherical | Infinite | 2.500 | Glass | 1.518 | 64.166 | | Refraction | 2.500 | 2.500 |
| S13 | right-angle | Spherical | Infinite | −2.500 | | | | | Reflection | 3.536 | 2.500 |
| S14 | prism | Spherical | Infinite | −2.707 | | | | | Refraction | 2.500 | 2.500 |
| S15 | Third right- | Spherical | Infinite | −2.500 | Glass | 1.518 | 64.166 | | Refraction | 2.500 | 2.500 |
| S16 | angle prism | Spherical | Infinite | 2.500 | | | | | Reflection | 3.536 | 2.500 |
| S17 | | Spherical | Infinite | 10.518 | | | | | Refraction | 2.500 | 2.500 |
| S18 | Imaging | Spherical | Infinite | 0.000 | | | | | Refraction | 2.285 | 2.285 |
| | plane | | | | | | | | | | |

TABLE 4
Embodiment 2
Aspheric coefficient

| Surface | | | | | | |
|---|---|---|---|---|---|---|
| number | S4 | S5 | S6 | S7 | S8 | S9 |
| K | 0.0000E+00 | 0.0000E+00 | 0.0000E+00 | 0.0000E+00 | 0.0000E+00 | 0.0000E+00 |
| A4 | −2.1400E−03 | −7.6900E−03 | 4.3000E−04 | 8.6000E−03 | −8.8000E−04 | −1.4000E−04 |
| A6 | 1.0000E−05 | 6.9000E−04 | 1.0600E−03 | 1.4900E−03 | 6.5000E−04 | 2.3000E−04 |
| A8 | 0.0000E+00 | −1.4000E−04 | −1.5000E−04 | −2.3000E−04 | −3.0000E−05 | 0.0000E+00 |
| A10 | 0.0000E+00 | 1.0000E−05 | 1.0000E−05 | 2.0000E−05 | 0.0000E+00 | 0.0000E+00 |
| Al2 | 0.0000E+00 | 0.0000E+00 | 0.0000E+00 | 0.0000E+00 | 0.0000E+00 | 0.0000E+00 |
| A14 | 0.0000E+00 | 0.0000E+00 | 0.0000E+00 | 0.0000E+00 | 0.0000E+00 | 0.0000E+00 |
| A16 | 0.0000E+00 | 0.0000E+00 | 0.0000E+00 | 0.0000E+00 | 0.0000E+00 | 0.0000E+30 |
| Al8 | 0.0000E+00 | 0.0000E+00 | 0.0000E+00 | 0.0000E+00 | 0.0000E+00 | 0.0000E+00 |
| A20 | 0.0000E+00 | 0.0000E+00 | 0.0000E+00 | 0.0000E+00 | 0.0000E+00 | 0.0000E+00 |

TABLE 5
Embodiment 2

| | | | |
|---|---|---|---|
| f (mm) | 25 | f/FNO (mm) | 3.84 |
| FNO | 6.51 | HFOV/TTL (degrees/mm) | 0.29 |
| HFOV (degrees) | 5.22 | TTL/f | 0.72 |
| TTL | 18.01 | CT12/CT23 | 0.282 |
| ImgH | 2.285 | D32/ImgH | 1 |

FIG. 8 shows graphs of longitudinal spherical aberration, astigmatism, and distortion of the lens system 10 according to Embodiment 2, respectively. The reference wavelength of the lens system 10 is 555 nm. The graph of longitudinal spherical aberration shows the deviation of the convergent focus of light rays with wavelengths of 470 nm, 510 nm, 555 nm, 610 nm, and 650 nm after passing through the lens system 10. The graph of astigmatism shows the curvature of meridian image plane and the curvature of sagittal image plane of the lens system 10. The graph of distortion shows the distortion of the lens system 10 with different image heights. According to FIG. 8, it can be seen that the lens system 10 provided in Embodiment 2 can achieve good imaging quality.

### Embodiment 3

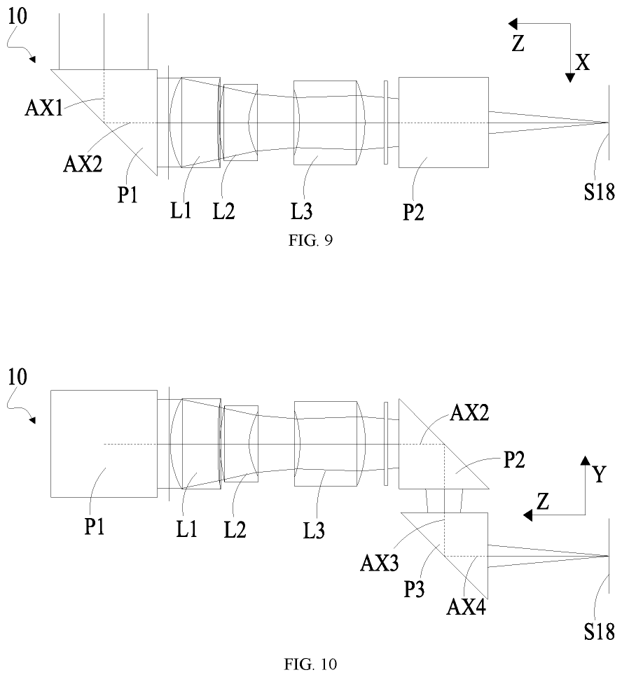

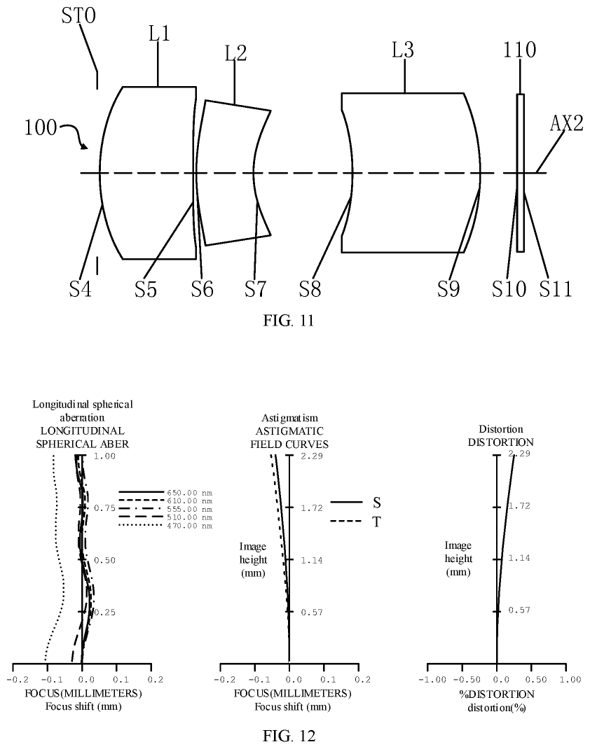

A lens system 10 of Embodiment 3 of the present disclosure will be described below with reference to FIGS. 9 to 12. In this embodiment, for the sake of brevity, some descriptions similar to those in Embodiment 1 will be omitted.

As shown in FIGS. 9 to 11, the lens system 10 includes, sequentially arranged from an object side to an image side along an optical axis, a first right-angle prism P1, a first lens L1, a second lens L2, a third lens L3, a second right-angle prism P2, a third right-angle prism P3, and an imaging plane S18. The folded optical axis includes a first part AX1, a second part AX2, a third part AX3, and a fourth part AX4. The first lens L1, the second lens L2, and the third lens L3 are located on the optical axis AX2.

The first right-angle prism P1 has a light incident surface S1, a reflective surface S2, and a light emergent surface S3.

The first lens L1 has a positive refractive power, and an object side surface S4 and an image side surface S5 thereof are both aspherical. The object side surface S4 is convex at the optical axis and is convex at its circumference, and the image side surface S5 is convex at the optical axis and is concave at its circumference. The second lens L2 has a negative refractive power, and an object side surface S6 and an image side surface S7 thereof are both aspherical. The object side surface S6 is convex at the optical axis and is concave at its circumference, and the image side surface S7 is concave at the optical axis and is convex at its circumference. The third lens L3 has a positive refractive power, and an object side surface S8 and an image side surface S9 thereof are both aspherical. The object side surface S8 is concave at the optical axis and is concave at its circumference, and the image side surface S9 is convex at the optical axis and is convex at its circumference.

The second right-angle prism P2 has a light incident surface S12, a reflective surface S13, and a light emergent surface S14.

The third right-angle prism P3 has a light incident surface S15, a reflective surface S16, and a light emergent surface S17.

The object side surfaces and the image side surfaces of the first lens L1 to the third lens L3 are all configured to be aspherical. The first lens L1 to the third lens L3 are all made of plastic. An optical stop STO is further disposed between the first right-angle prism P1 and the first lens L1. The lens system 10 further includes an infrared filter 110 disposed on an image side of the third lens L3 and having an object side surface S10 and an image side surface S11.

Table 6 shows the surface type, radius of curvature, thickness, material, refractive index, Abbe number (that is, dispersion coefficient), effective focal length, Y-half aperture, and X-half aperture of each of the lenses of the lens system 10 according to Embodiment 3, where the units of the radius of curvature, the thickness, the effective focal length of each of the lenses, the Y-half aperture, and the X-half aperture are all millimeters (mm) Table 7 shows the high-order term coefficients that can be used for the lens aspherical surfaces S4 to S9 in Embodiment 3, where the surface shape of the aspherical surface can be defined by the equation (1) provided in Embodiment 1. Table 8 shows values of relevant parameters of the lens system 10 given in Embodiment 3.

TABLE 6
Embodiment 3
f = 29.84 mm, FNO = 5.5, HFOV = 4.370, TTL = 19.94 mm

| Surface | Surface | Surface | Radius of | Thick− | | Refractive | Abbe | Focal | Refraction | Y-half | X-half |
|---|---|---|---|---|---|---|---|---|---|---|---|
| number | name | type | curvature | ness | Material | index | number | length | mode | aperture | aperture |
| OBJ | Object plane | Spherical | Infinite | Infinite | | | | | Refraction | | |
| S1 | First right- | Spherical | Infinite | −3.250 | Glass | 1.518 | 64.166 | | Refraction | 3.250 | 3.250 |
| S2 | angle prism | Spherical | Infinite | 3.250 | | | | | Reflection | 3.250 | 4.596 |
| S3 | | Spherical | Infinite | 0.700 | | | | | Refraction | 3.250 | 3.250 |
| STO | Optical stop | Spherical | Infinite | 0.080 | | | | | Refraction | 2.713 | 2.713 |
| S4 | First lens | Aspherical | 6.183 | 2.925 | Plastic | 1.546 | 56.114 | 11.223 | Refraction | 2.774 | 2.774 |
| S5 | | Aspherical | −559.850 | 0.100 | | | | | Refraction | 2.390 | 2.390 |
| S6 | Second lens | Aspherical | 7.606 | 1.787 | Plastic | 1.644 | 23.517 | −10.338 | Refraction | 2.337 | 2.337 |
| S7 | | Aspherical | 3.223 | 3.103 | | | | | Refraction | 2.004 | 2.004 |
| S8 | Third lens | Aspherical | −6.965 | 4.000 | Plastic | 1.546 | 56.114 | 52.000 | Refraction | 2.026 | 2.026 |
| S9 | | Aspherical | −6.727 | 1.155 | | | | | Refraction | 2.563 | 2.563 |
| S10 | Infrared | Spherical | Infinite | 0.210 | Glass | 1.518 | 64.166 | | Refraction | 2.538 | 2.538 |
| S11 | filter | Spherical | Infinite | 0.689 | | | | | Refraction | 2.536 | 2.536 |
| S12 | Second | Spherical | Infinite | 2.750 | Glass | 1.518 | 64.166 | | Refraction | 2.750 | 2.750 |
| S13 | right-angle | Spherical | Infinite | −2.750 | | | | | Reflection | 3.889 | 2.750 |
| S14 | prism | Spherical | Infinite | −1.443 | | | | | Refraction | 2.750 | 2.750 |
| S15 | Third right- | Spherical | Infinite | −2.650 | Glass | 1.518 | 64.166 | | Refraction | 2.650 | 2.650 |
| S16 | angle prism | Spherical | Infinite | 2.650 | | | | | Reflection | 3.748 | 2.650 |
| S17 | | Spherical | Infinite | 7.414 | | | | | Refraction | 2.650 | 2.650 |
| S18 | Imaging | Spherical | Infinite | 0.000 | | | | | Refraction | 2.285 | 2.285 |
| | plane | | | | | | | | | | |

TABLE 7
Embodiment 3
Aspheric coefficient

| Surface | | | | | | |
|---|---|---|---|---|---|---|
| number | S4 | S5 | S6 | S7 | S8 | S9 |
| K | 0.0000E+00 | 0.0000E+00 | 0.0000E+00 | 0.0000E+00 | 0.0000E+00 | 0.0000E+00 |
| A4 | −5.1000E−04 | −3.8800E−03 | −2.1000E−04 | 5.3900E−03 | 4.7000E−04 | 8.0000E−05 |
| A6 | −8.0000E−05 | 6.7000E−04 | 1.1500E−03 | 1.6600E−03 | 5.1000E−04 | 6.0000E−05 |
| A8 | 0.0000E+00 | −1.4000E−04 | −1.8000E−04 | −2.1000E−04 | −2.0000E−05 | 0.0000E+00 |
| A10 | 0.0000E+00 | 1.0000E−05 | 1.0000E−05 | 1.0000E−05 | 0.0000E+00 | 0.0000E+00 |
| Al2 | 0.0000E+00 | 0.0000E+00 | 0.0000E+00 | 0.0000E+00 | 0.0000E+00 | 0.0000E+00 |
| A14 | 0.0000E+00 | 0.0000E+00 | 0.0000E+00 | 0.0000E+00 | 0.0000E+00 | 0.0000E+00 |
| A16 | 0.0000E+00 | 0.0000E+00 | 0.0000E+00 | 0.0000E+00 | 0.0000E+00 | 0.0000E+00 |
| A18 | 0.0000E+00 | 0.0000E+00 | 0.0000E+00 | 0.0000E+00 | 0.0000E+00 | 0.0000E+00 |
| A20 | 0.0000E+00 | 0.0000E+00 | 0.0000E+00 | 0.0000E+00 | 0.0000E+00 | 0.0000E+00 |

TABLE 8
Embodiment 3

| | | | |
|---|---|---|---|
| f (mm) | 29.84 | f/FNO (mm) | 5.425 |
| FNO | 5.5 | HFOV/TTL (degrees/mm) | 0.219 |
| HFOV (degrees) | 4.37 | TTL/f | 0.668 |
| TTL | 19.94 | CT12/CT23 | 0.032 |
| ImgH | 2.285 | D32/ImgH | 1.122 |

FIG. 12 shows graphs of longitudinal spherical aberration, astigmatism, and distortion of the lens system 10 according to Embodiment 3, respectively. The reference wavelength of the lens system 10 is 555 nm. The graph of longitudinal spherical aberration shows the deviation of the convergent focus of light rays with wavelengths of 470 nm, 510 nm, 555 nm, 610 nm, and 650 nm after passing through the lens system 10. The graph of astigmatism shows the curvature of meridian image plane and the curvature of sagittal image plane of the lens system 10. The graph of distortion shows the distortion of the lens system 10 with different image heights. According to FIG. 12, it can be seen that the lens system 10 provided in Embodiment 3 can achieve good imaging quality.

### Embodiment 4

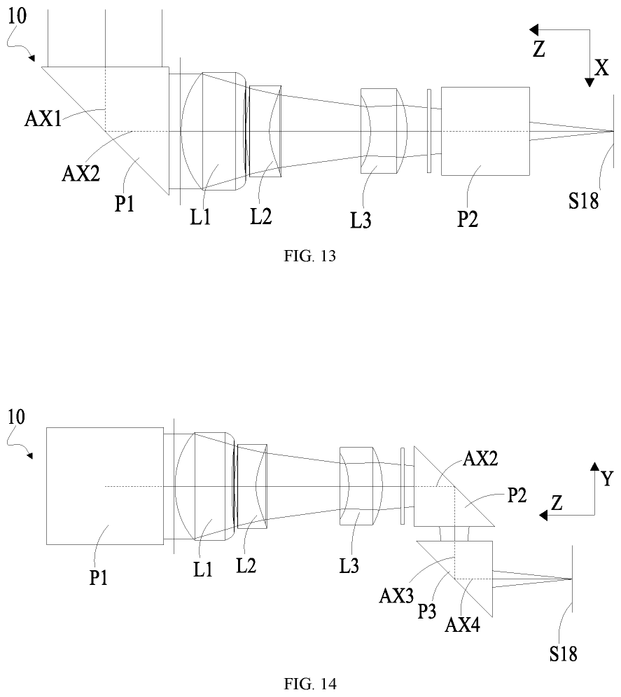

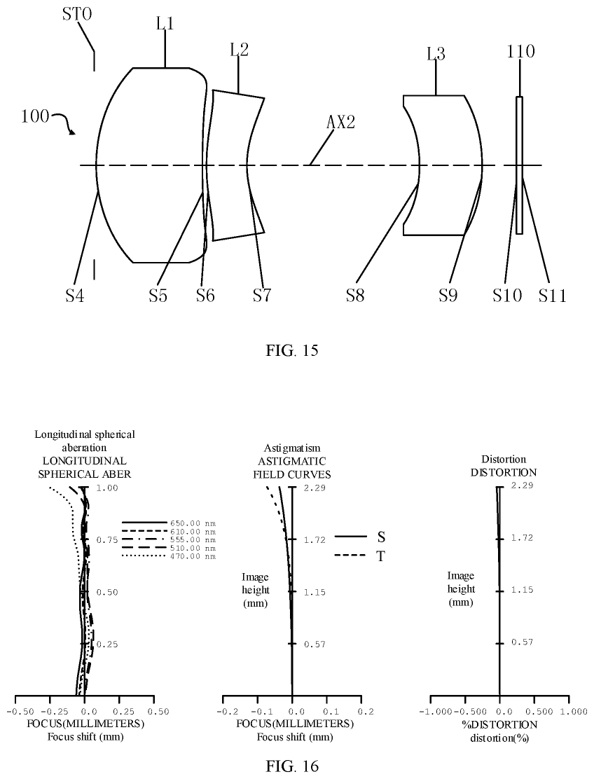

A lens system 10 of Embodiment 4 of the present disclosure will be described below with reference to FIGS. 13 to 16. In this embodiment, for the sake of brevity, some descriptions similar to those in Embodiment 1 will be omitted.

As shown in FIGS. 13 to 15, the lens system 10 includes, sequentially arranged from an object side to an image side along an optical axis, a first right-angle prism P1, a first lens L1, a second lens L2, a third lens L3, a second right-angle prism P2, a third right-angle prism P3, and an imaging plane S18. The folded optical axis includes a first part AX1, a second part AX2, a third part AX3, and a fourth part AX4. The first lens L1, the second lens L2, and the third lens L3 are located on the optical axis AX2.

The first right-angle prism P1 has a light incident surface S1, a reflective surface S2, and a light emergent surface S3.

The first lens L1 has a positive refractive power, and an object side surface S4 and an image side surface S5 thereof are both aspherical. The object side surface S4 is convex at the optical axis and is convex at its circumference, and the image side surface S5 is concave at the optical axis and is convex at its circumference. The second lens L2 has a negative refractive power, and an object side surface S6 and an image side surface S7 thereof are both aspherical. The object side surface S6 is convex at the optical axis and is concave at its circumference, and the image side surface S7 is concave at the optical axis and is convex at its circumference. The third lens L3 has a negative refractive power, and an object side surface S8 and an image side surface S9 thereof are both aspherical. The object side surface S8 is concave at the optical axis and is concave at its circumference, and the image side surface S9 is convex at the optical axis and is convex at its circumference.

The second right-angle prism P2 has a light incident surface S12, a reflective surface S13, and a light emergent surface S14.

The third right-angle prism P3 has a light incident surface S15, a reflective surface S16, and a light emergent surface S17.

The object side surfaces and the image side surfaces of the first lens L1 to the third lens L3 are all configured to be aspherical. The first lens L1 to the third lens L3 are all made of plastic. An optical stop STO is further disposed between the first right-angle prism P1 and the first lens L1. The lens system 10 further includes an infrared filter 110 disposed on an image side of the third lens L3 and having an object side surface S10 and an image side surface S11.

Table 9 shows the surface type, radius of curvature, thickness, material, refractive index, Abbe number (that is, dispersion coefficient), effective focal length, Y-half aperture, and X-half aperture of each of the lenses of the lens system 10 according to Embodiment 4, where the units of the radius of curvature, the thickness, the effective focal length of each of the lenses, the Y-half aperture, and the X-half aperture are all millimeters (mm) Table 10 shows the high-order term coefficients that can be used for the lens aspherical surfaces S4 to S9 in Embodiment 4, where the surface shape of the aspherical surface can be defined by the equation (1) provided in Embodiment 1. Table 11 shows values of relevant parameters of the lens system 10 given in Embodiment 4.

TABLE 9
Embodiment 4
f = 35.17 mm, FNO = 4.9, HFOV = 3.721°, TTL = 20.80 mm

| | | | | | | Refrac- | | | | | |
|---|---|---|---|---|---|---|---|---|---|---|---|
| Surface | Surface | Surface | Radius of | Thick- | | tive | Abbe | Focal | Refraction | Y-half | X-half |
| number | name | type | curvature | ness | Material | index | number | length | mode | aperture | aperture |
| OBJ | Object | Spherical | Infinite | Infinite | | | | | Refraction | | |
| | plane | | | | | | | | | | |
| S1 | First right- | Spherical | Infinite | −4.000 | Glass | 1.518 | 64.166 | | Refraction | 4.000 | 4.000 |
| S2 | angle | Spherical | Infinite | 4.000 | | | | | Reflection | 4.000 | 5.657 |
| S3 | prism | Spherical | Infinite | 0.700 | | | | | Refraction | 4.000 | 4.000 |
| STO | Optical | Spherical | Infinite | 0.070 | | | | | Refraction | 3.589 | 3.589 |
| | stop | | | | | | | | | | |
| S4 | First lens | Aspherical | 6.140 | 3.900 | Plastic | 1.546 | 56.114 | 12.467 | Refraction | 3.681 | 3.681 |
| S5 | | Aspherical | 48.646 | 0.150 | | | | | Refraction | 2.953 | 2.953 |
| S6 | Second | Aspherical | 8.264 | 1.483 | Plastic | 1.644 | 23.517 | −12.921 | Refraction | 2.858 | 2.858 |
| S7 | lens | Aspherical | 3.855 | 6.336 | | | | | Refraction | 2.543 | 2.543 |
| S8 | Third lens | Aspherical | −5.337 | 2.300 | Plastic | 1.546 | 56.114 | −1017.725 | Refraction | 2.233 | 2.233 |
| S9 | | Aspherical | −6.208 | 1.265 | | | | | Refraction | 2.642 | 2.642 |
| S10 | Infrared | Spherical | Infinite | 0.210 | Glass | 1.518 | 64.166 | | Refraction | 2.598 | 2.598 |
| S11l | filter | Spherical | Infinite | 0.689 | | | | | Refraction | 2.595 | 2.595 |
| S12 | Second | Spherical | Infinite | 2.750 | Glass | 1.518 | 64.166 | | Refraction | 2.750 | 2.750 |
| S13 | right-angle | Spherical | Infinite | −2.750 | | | | | Reflection | 3.889 | 2.750 |
| S14 | prism | Spherical | Infinite | −0.976 | | | | | Refraction | 2.750 | 2.750 |
| S15 | Third | Spherical | Infinite | −2.600 | Glass | 1.518 | 64.166 | | Refraction | 2.600 | 2.600 |
| S16 | right-angle | Spherical | Infinite | 2.600 | | | | | Reflection | 3.677 | 2.600 |
| S17 | prism | Spherical | Infinite | 5.446 | | | | | Refraction | 2.600 | 2.600 |
| S18 | Imaging | Spherical | Infinite | 0.000 | | | | | Refraction | 2.285 | 2.285 |
| | plane | | | | | | | | | | |

TABLE 10
Embodiment 4
Aspheric coefficient

| Surface | | | | | | |
|---|---|---|---|---|---|---|
| number | S4 | S5 | S6 | S7 | S8 | S9 |
| K | 0.0000E+00 | 0.0000E+00 | 0.0000E+00 | 0.0000E+00 | 0.0000E+00 | 0.0000E+00 |
| A4 | −1.5000E−04 | −2.5300E−03 | 4.5000E−04 | 4.2600E−03 | 2.0900E−03 | 9.7000E−04 |
| A6 | −3.0000E−05 | 7.4000E−04 | 1.2500E−03 | 1.2500E−03 | 7.2000E−04 | 2.0000E−04 |
| A8 | 0.0000E+00 | −1.4000E−04 | −1.8000E−04 | −1.7000E−04 | −1.0000E−04 | −2.0000E−05 |
| A10 | 0.0000E+00 | 1.0000E−05 | 1.0000E−05 | 1.0000E−05 | 1.0000E−05 | 0.0000E+00 |
| A12 | 0.0000E+00 | 0.0000E+00 | 0.0000E+00 | 0.0000E+00 | 0.0000E+00 | 0.0000E+00 |
| A14 | 0.0000E+00 | 0.0000E+00 | 0.0000E+00 | 0.0000E+00 | 0.0000E+00 | 0.0000E+00 |
| A16 | 0.0000E+00 | 0.0000E+00 | 0.0000E+00 | 0.0000E+00 | 0.0000E+00 | 0.0000E+00 |
| A18 | 0.0000E+00 | 0.0000E+00 | 0.0000E+00 | 0.0000E+00 | 0.0000E+00 | 0.0000E+00 |
| A20 | 0.0000E+00 | 0.0000E+00 | 0.0000E+00 | 0.0000E+00 | 0.0000E+00 | 0.0000E+00 |

TABLE 11
Embodiment 4

| | | | |
|---|---|---|---|
| f (mm) | 35.17 | f/FNO (mm) | 7.177 |
| FNO | 4.9 | HFOV/TTL (degrees/mm) | 0.179 |
| HFOV (degrees) | 3.721 | TTL/f | 0.592 |
| TTL | 20.8 | CT12/CT23 | 0.024 |
| ImgH | 2.285 | D32/ImgH | 1.156 |

FIG. 16 shows graphs of longitudinal spherical aberration, astigmatism, and distortion of the lens system 10 according to Embodiment 4, respectively. The reference wavelength of the lens system 10 is 555 nm. The graph of longitudinal spherical aberration shows the deviation of the convergent focus of light rays with wavelengths of 470 nm, 510 nm, 555 nm, 610 nm, and 650 nm after passing through the lens system 10. The graph of astigmatism shows the curvature of meridian image plane and the curvature of sagittal image plane of the lens system 10. The graph of distortion shows the distortion of the lens system 10 with different image heights. According to FIG. 16, it can be seen that the lens system 10 provided in Embodiment 4 can achieve good imaging quality.

### Embodiment 5

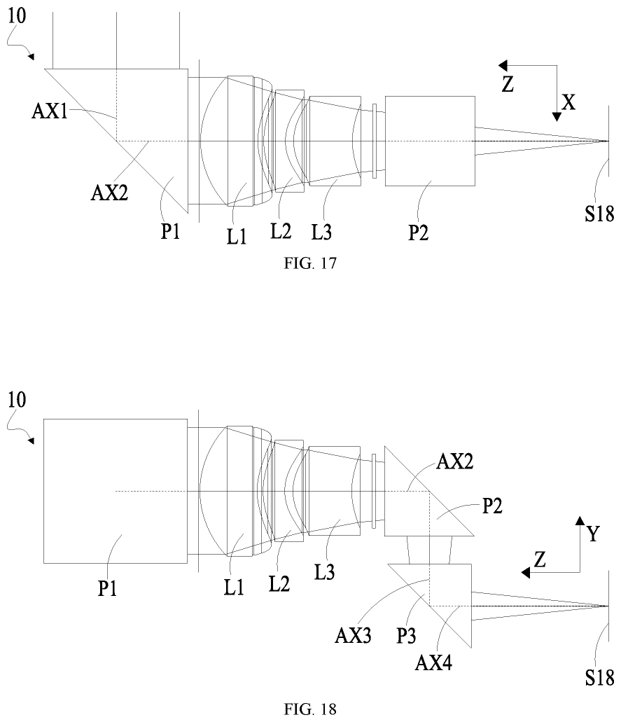

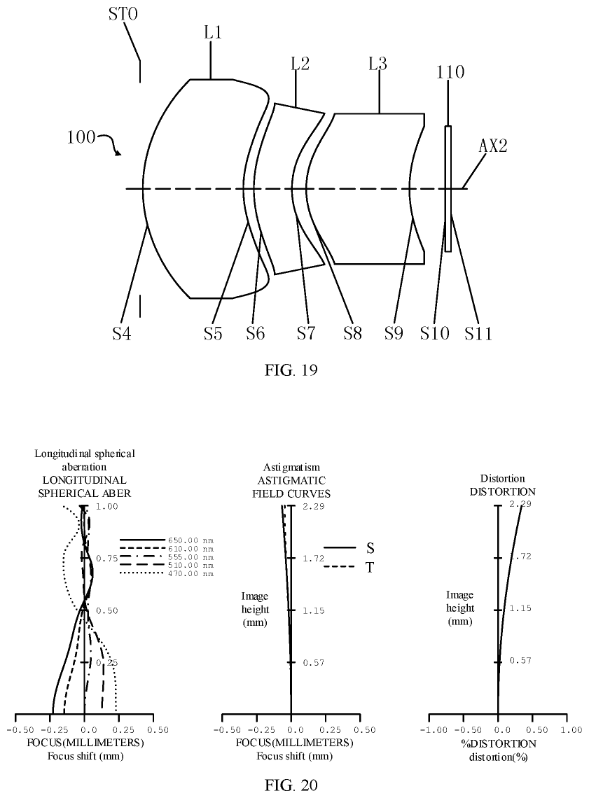

A lens system 10 of Embodiment 5 of the present disclosure will be described below with reference to FIGS. 17 to 20. In this embodiment, for the sake of brevity, some descriptions similar to those in Embodiment 1 will be omitted.

As shown in FIGS. 17 to 19, the lens system 10 includes, sequentially arranged from an object side to an image side along an optical axis, a first right-angle prism P1, a first lens L1, a second lens L2, a third lens L3, a second right-angle prism P2, a third right-angle prism P3, and an imaging plane S18. The folded optical axis includes a first part AX1, a second part AX2, a third part AX3, and a fourth part AX4. The first lens L1, the second lens L2, and the third lens L3 are located on the optical axis AX2.

The first right-angle prism P1 has a light incident surface S1, a reflective surface S2, and a light emergent surface S3.

The first lens L1 has a negative refractive power, and an object side surface S4 and an image side surface S5 thereof are both aspherical. The object side surface S4 is convex at the optical axis and is convex at its circumference, and the image side surface S5 is concave at the optical axis and is convex at its circumference. The second lens L2 has a negative refractive power, and an object side surface S6 and an image side surface S7 thereof are both aspherical. The object side surface S6 is convex at the optical axis and is concave at its circumference, and the image side surface S7 is concave at the optical axis and is convex at its circumference. The third lens L3 has a positive refractive power, and an object side surface S8 and an image side surface S9 thereof are both aspherical. The object side surface S8 is convex at the optical axis and is concave at its circumference, and the image side surface S9 is concave at the optical axis and is concave at its circumference.

The second right-angle prism P2 has a light incident surface S12, a reflective surface S13, and a light emergent surface S14.

The third right-angle prism P3 has a light incident surface S15, a reflective surface S16, and a light emergent surface S17.

The object side surfaces and the image side surfaces of the first lens L1 to the third lens L3 are all configured to be aspherical. The first lens L1 to the third lens L3 are all made of plastic. An optical stop STO is further disposed between the first right-angle prism P1 and the first lens L1. The lens system 10 further includes an infrared filter 110 disposed on an image side of the third lens L3 and having an object side surface S10 and an image side surface S11.

Table 12 shows the surface type, radius of curvature, thickness, material, refractive index, Abbe number (that is, dispersion coefficient), effective focal length, Y-half aperture, and X-half aperture of each of the lenses of the lens system 10 according to Embodiment 5, where the units of the radius of curvature, the thickness, the effective focal length of each of the lenses, the Y-half aperture, and the X-half aperture are all millimeters (mm) Table 13 shows the high-order term coefficients that can be used for the lens aspherical surfaces S4 to S9 in Embodiment 5, where the surface shape of the aspherical surface can be defined by the equation (1) provided in Embodiment 1. Table 14 shows values of relevant parameters of the lens system 10 given in Embodiment 5.

TABLE 12
Embodiment 5
f = 40 mm, FNO = 4.9, HFOV = 3.26°, TTL = 19.00 mm

| Surface | Surface | Surface | Radius of | | | Refractive | Abbe | Focal | Refraction | Y-half | X-half |
|---|---|---|---|---|---|---|---|---|---|---|---|
| number | name | type | curvature | Thickness | Material | index | number | length | mode | aperture | aperture |
| OBJ | Object plane | Spherical | Infinite | Infinite | | | | | Refraction | | |
| S1 | First right- | Spherical | Infinite | −4.650 | Glass | 1.518 | 64.166 | | Refraction | 4.650 | 4.650 |
| S2 | angle prism | Spherical | Infinite | 4.650 | | | | | Reflection | 4.650 | 6.576 |
| S3 | | Spherical | Infinite | 0.700 | | | | | Refraction | 4.650 | 4.650 |
| STO | Optical stop | Spherical | Infinite | 0.100 | | | | | Refraction | 4.082 | 4.082 |
| S4 | First lens | Aspherical | 5.580 | 3.700 | Plastic | 1.546 | 56.114 | −999.999 | Refraction | 4.187 | 4.187 |
| S5 | | Aspherical | 4.230 | 0.390 | | | | | Refraction | 3.356 | 3.356 |
| S6 | Second lens | Aspherical | 4.981 | 1.400 | Plastic | 1.644 | 23.517 | −921.028 | Refraction | 3.274 | 3.274 |
| S7 | | Aspherical | 3.241 | 0.527 | | | | | Refraction | 2.890 | 2.890 |
| S8 | Third lens | Aspherical | 3.232 | 3.800 | Plastic | 1.546 | 56.114 | 9.637 | Refraction | 2.874 | 2.874 |
| S9 | | Aspherical | 4.903 | 1.321 | | | | | Refraction | 2.403 | 2.403 |
| S10 | Infrared | Spherical | Infinite | 0.210 | Glass | 1.518 | 64.166 | | Refraction | 2.398 | 2.398 |
| S11 | filter | Spherical | Infinite | 0.590 | | | | | Refraction | 2.397 | 2.397 |
| S12 | Second | Spherical | Infinite | 2.900 | Glass | 1.518 | 64.166 | | Refraction | 2.900 | 2.900 |
| S13 | right-angle | Spherical | Infinite | −2.900 | | | | | Reflection | 4.101 | 2.900 |
| S14 | prism | Spherical | Infinite | −1.812 | | | | | Refraction | 2.900 | 2.900 |
| S15 | Third right- | Spherical | Infinite | −2.700 | Glass | 1.518 | 64.166 | | Refraction | 2.700 | 2.700 |
| S16 | angle prism | Spherical | Infinite | 2.700 | | | | | Reflection | 3.818 | 2.700 |
| S17 | | Spherical | Infinite | 8.872 | | | | | Refraction | 2.700 | 2.700 |
| S18 | Imaging | Spherical | Infinite | 0.000 | | | | | Refraction | 2.285 | 2.285 |
| | plane | | | | | | | | | | |

TABLE 13
Embodiment 5
Aspheric coefficient

| Surface | | | | | | |
|---|---|---|---|---|---|---|
| number | S4 | S5 | S6 | S7 | S8 | S9 |
| K | 0.0000E+00 | 0.0000E+00 | 0.0000E+00 | 0.0000E+00 | 0.0000E+00 | 0.0000E+00 |
| A4 | 4.0000E−04 | 4.6100E−03 | 6.7000E−04 | −4.7700E−03 | −1.7000E−04 | 6.6000E−04 |
| A6 | 2.0000E−05 | 7.8000E−04 | 1.0900E−03 | 2.2900E−03 | 1.5400E−03 | 3.7000E−04 |
| A8 | 0.0000E+00 | −1.4000E−04 | −1.5000E−04 | −2.0000E−04 | −1.1000E−04 | 2.0000E−05 |
| A10 | 0.0000E+00 | 1.0000E−05 | 1.0000E−05 | 1.0000E−05 | 1.0000E−05 | 0.0000E+00 |
| A12 | 0.0000E+00 | 0.0000E+00 | 0.0000E+00 | 0.0000E+00 | 0.0000E+00 | 0.0000E+00 |
| A14 | 0.0000E+00 | 0.0000E+00 | 0.0000E+00 | 0.0000E+00 | 0.0000E+00 | 0.0000E+00 |
| A16 | 0.0000E+00 | 0.0000E+00 | 0.0000E+00 | 0.0000E+00 | 0.0000E+00 | 0.0000E+00 |
| A18 | 0.0000E+00 | 0.0000E+00 | 0.0000E+00 | 0.0000E+00 | 0.0000E+00 | 0.0000E+00 |
| A20 | 0.0000E+00 | 0.0000E+00 | 0.0000E+00 | 0.0000E+00 | 0.0000E+00 | 0.0000E+00 |

TABLE 14
Embodiment 5

| | | | |
|---|---|---|---|
| f (mm) | 40 | f/FNO (mm) | 8.163 |
| FNO | 4.9 | HFOV/TTL (degrees/mm) | 0.172 |
| HFOV (degrees) | 3.26 | TTL/f | 0.475 |
| TTL | 19.0 | CT12/CT23 | 0.739 |
| ImgH | 2.285 | D32/ImgH | 1.052 |

FIG. 20 shows graphs of longitudinal spherical aberration, astigmatism, and distortion of the lens system 10 according to Embodiment 5, respectively. The reference wavelength of the lens system 10 is 555 nm. The graph of longitudinal spherical aberration shows the deviation of the convergent focus of light rays with wavelengths of 470 nm, 510 nm, 555 nm, 610 nm, and 650 nm after passing through the lens system 10. The graph of astigmatism shows the curvature of meridian image plane and the curvature of sagittal image plane of the lens system 10. The graph of distortion shows the distortion of the lens system 10 with different image heights. According to FIG. 20, it can be seen that the lens system 10 provided in Embodiment 5 can achieve good imaging quality.

### Embodiment 6

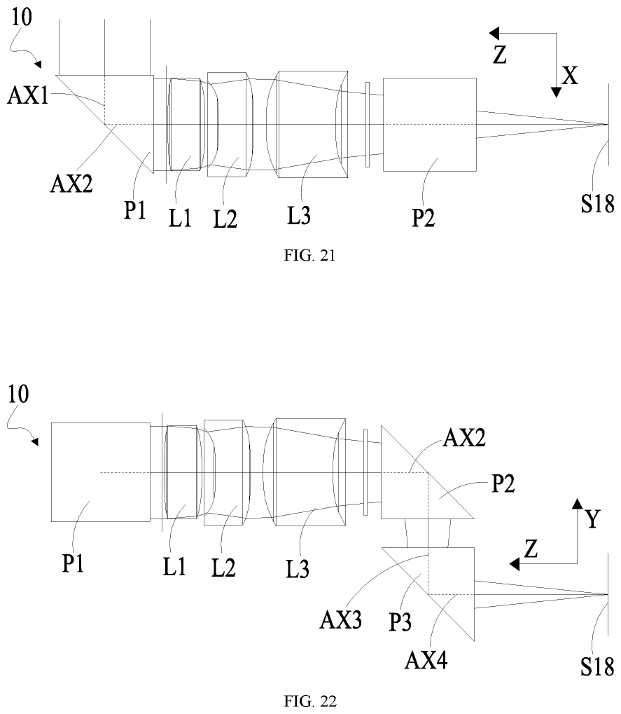

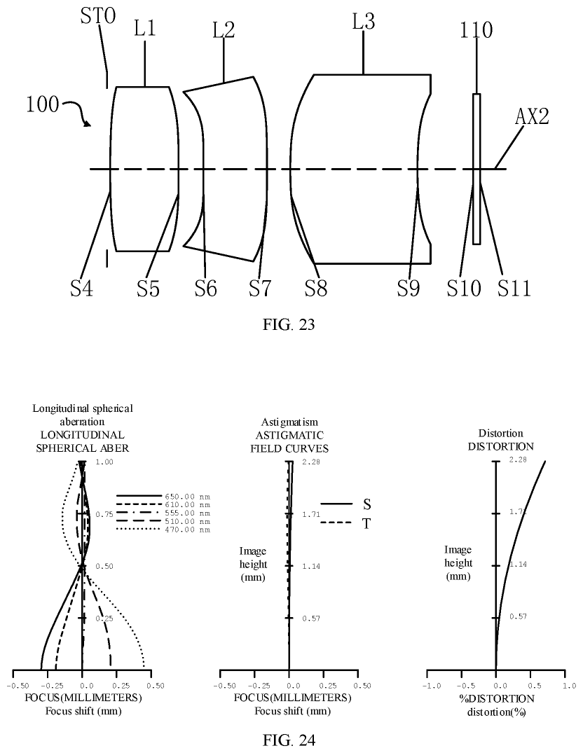

A lens system 10 of Embodiment 6 of the present disclosure will be described below with reference to FIGS. 21 to 24. In this embodiment, for the sake of brevity, some descriptions similar to those in Embodiment 1 will be omitted.

As shown in FIGS. 21 to 23, the lens system 10 includes, sequentially arranged from an object side to an image side along an optical axis, a first right-angle prism P1, a first lens L1, a second lens L2, a third lens L3, a second right-angle prism P2, a third right-angle prism P3, and an imaging plane S18. The folded optical axis includes a first part AX1, a second part AX2, a third part AX3, and a fourth part AX4. The first lens L1, the second lens L2, and the third lens L3 are located on the optical axis AX2.

The first right-angle prism P1 has a light incident surface S1, a reflective surface S2, and a light emergent surface S3.

The first lens L1 has a positive refractive power, and an object side surface S4 and an image side surface S5 thereof are both aspherical. The object side surface S4 is convex at the optical axis and is convex at its circumference, and the image side surface S5 is convex at the optical axis and is convex at its circumference. The second lens L2 has a positive refractive power, and an object side surface S6 and an image side surface S7 thereof are both aspherical. The object side surface S6 is convex at the optical axis and is concave at its circumference, and the image side surface S7 is convex at the optical axis and is convex at its circumference. The third lens L3 has a negative refractive power, and an object side surface S8 and an image side surface S9 thereof are both aspherical. The object side surface S8 is convex at the optical axis and is convex at its circumference, and the image side surface S9 is concave at the optical axis and is concave at its circumference.

The second right-angle prism P2 has a light incident surface S12, a reflective surface S13, and a light emergent surface S14.

The third right-angle prism P3 has a light incident surface S15, a reflective surface S16, and a light emergent surface S17.

The object side surfaces and the image side surfaces of the first lens L1 to the third lens L3 are all configured to be aspherical. The first lens L1 to the third lens L3 are all made of plastic. An optical stop STO is further disposed between the first right-angle prism P1 and the first lens L1. The lens system 10 further includes an infrared filter 110 disposed on an image side of the third lens L3 and having an object side surface S10 and an image side surface S11.

Table 15 shows the surface type, radius of curvature, thickness, material, refractive index, Abbe number (that is, dispersion coefficient), effective focal length, Y-half aperture, and X-half aperture of each of the lenses of the lens system 10 according to Embodiment 6, where the units of the radius of curvature, the thickness, the effective focal length of each of the lenses, the Y-half aperture, and the X-half aperture are all millimeters (mm) Table 16 shows the high-order term coefficients that can be used for the lens aspherical surfaces S4 to S9 in Embodiment 6, where the surface shape of the aspherical surface can be defined by the equation (1) provided in Embodiment 1. Table 17 shows values of relevant parameters of the lens system 10 given in Embodiment 6.

TABLE 15
Embodiment 6
f = 25.13 mm, FNO = 4.9, HFOV = 5.16°, TTL = 18.01 mm

| Surface | Surface | Surface | Radius of | | | Refractive | Abbe | Focal | Refraction | Y-half | X-half |
|---|---|---|---|---|---|---|---|---|---|---|---|
| number | name | type | curvature | Thickness | Material | index | number | length | mode | aperture | aperture |
| OBJ | Object plane | Spherical | Infinite | Infinite | | | | | Refraction | | |
| S1 | First right- | Spherical | Infinite | −2.750 | Glass | 1.518 | 64.166 | | Refraction | 2.750 | 2.750 |
| S2 | angle prism | Spherical | Infinite | 2.750 | | | | | Reflection | 2.750 | 3.889 |
| S3 | | Spherical | Infinite | 0.700 | | | | | Refraction | 2.750 | 2.750 |
| STO | Optical stop | Spherical | Infinite | 0.100 | | | | | Refraction | 2.564 | 2.564 |
| S4 | First lens | Aspherical | 37.934 | 2.100 | Plastic | 1.546 | 56.114 | 52.000 | Refraction | 2.590 | 2.590 |
| S5 | | Aspherical | −110.612 | 0.760 | | | | | Refraction | 2.547 | 2.547 |
| S6 | Second lens | Aspherical | 57.291 | 1.950 | Plastic | 1.644 | 23.517 | 52.754 | Refraction | 2.439 | 2.439 |
| S7 | | Aspherical | −82.366 | 0.717 | | | | | Refraction | 2.914 | 2.914 |
| S8 | Third lens | Aspherical | 17.272 | 3.900 | Plastic | 1.546 | 56.114 | 1000.212 | Refraction | 2.984 | 2.984 |
| S9 | | Aspherical | 15.408 | 1.709 | | | | | Refraction | 2.377 | 2.377 |
| S10 | Infrared | Spherical | Infinite | 0.210 | Glass | 1.518 | 64.166 | | Refraction | 2.370 | 2.370 |
| S11 | filter | Spherical | Infinite | 0.788 | | | | | Refraction | 2.369 | 2.369 |
| S12 | Second | Spherical | Infinite | 2.600 | | | | | Refraction | 2.600 | 2.600 |
| S13 | right-angle | Spherical | Infinite | −2.600 | Glass | 1.518 | 64.166 | | Reflection | 3.677 | 2.600 |
| S14 | prism | Spherical | Infinite | −1.575 | | | | | Refraction | 2.600 | 2.600 |
| S15 | Third right- | Spherical | Infinite | −2.600 | Glass | 1.518 | 64.166 | | Refraction | 2.600 | 2.600 |
| S16 | angle prism | Spherical | Infinite | 2.600 | | | | | Reflection | 3.677 | 2.600 |
| S17 | | Spherical | Infinite | 7.451 | | | | | Refraction | 2.600 | 2.600 |
| S18 | Imaging | Spherical | Infinite | 0.000 | | | | | Refraction | 2.285 | 2.285 |
| plane | | | | | | | | | | | |

TABLE 16
Embodiment 6
Aspheric coefficient

| Surface | | | | | | |
|---|---|---|---|---|---|---|
| number | S4 | S5 | S6 | S7 | S8 | S9 |
| K | 0.0000E+00 | 0.0000E+00 | 0.0000E+00 | 0.0000E+00 | 0.0000E+00 | 0.0000E+00 |
| A4 | −2.1500E−03 | 8.5600E−03 | 1.9110E−02 | 1.8600E−03 | −1.5240E−02 | −7.3700E−03 |
| A6 | 1.2000E−04 | −1.8000E−04 | 7.9000E−04 | 1.1400E−03 | 2.0700E−03 | 6.0000E−05 |
| A8 | −3.0000E−05 | −8.0000E−05 | −1.9000E−04 | −1.3000E−04 | −1.7000E−04 | −2.0000E−05 |
| A10 | 0.0000E+00 | 1.0000E−05 | 1.0000E−05 | 0.0000E+00 | 1.0000E−05 | 0.0000E+00 |
| A12 | 0.0000E+00 | 0.0000E+00 | 0.0000E+00 | 0.0000E+00 | 0.0000E+00 | 0.0000E+00 |
| A14 | 0.0000E+00 | 0.0000E+00 | 0.0000E+00 | 0.0000E+00 | 0.0000E+00 | 0.0000E+00 |
| A16 | 0.0000E+00 | 0.0000E+00 | 0.0000E+00 | 0.0000E+00 | 0.0000E+00 | 0.0000E+00 |
| A18 | 0.0000E+00 | 0.0000E+00 | 0.0000E+00 | 0.0000E+00 | 0.0000E+00 | 0.0000E+00 |
| A20 | 0.0000E+00 | 0.0000E+00 | 0.0000E+00 | 0.0000E+00 | 0.0000E+00 | 0.0000E+00 |

TABLE 17
Embodiment 6

| | | | |
|---|---|---|---|
| f (mm) | 25.13 | f/FNO (mm) | 5.128 |
| ENO | 4.9 | HFOV/TTL (degrees/mm) | 0.287 |
| HFOV (degrees) | 5.16 | TTL/f | 0.717 |
| TTL | 18.01 | CT12/CT23 | 1.06 |
| ImgH | 2.285 | D32/ImgH | 1.04 |

FIG. 24 shows graphs of longitudinal spherical aberration, astigmatism, and distortion of the lens system 10 according to Embodiment 6, respectively. The reference wavelength of the lens system 10 is 555 nm. The graph of longitudinal spherical aberration shows the deviation of the convergent focus of light rays with wavelengths of 470 nm, 510 nm, 555 nm, 610 nm, and 650 nm after passing through the lens system 10. The graph of astigmatism shows the curvature of meridian image plane and the curvature of sagittal image plane of the lens system 10. The graph of distortion shows the distortion of the lens system 10 with different image heights. According to FIG. 24, it can be seen that the lens system 10 provided in Embodiment 6 can achieve good imaging quality.

### Embodiment 7

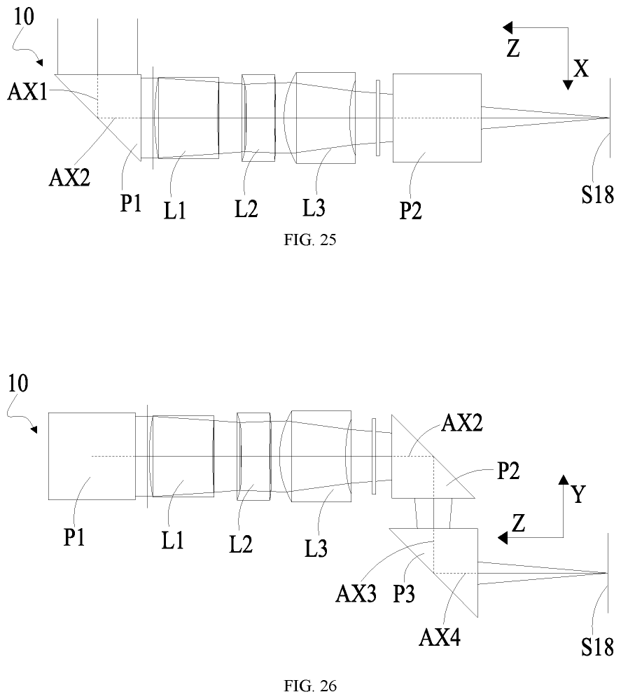

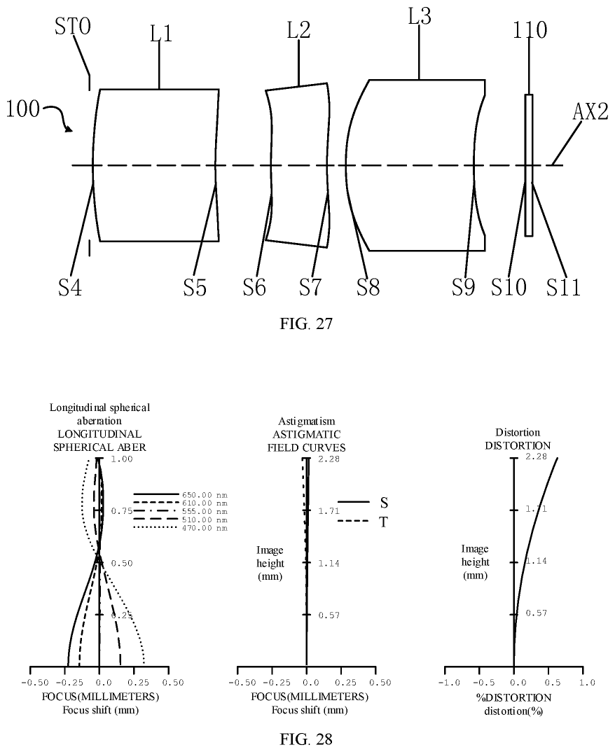

A lens system 10 of Embodiment 7 of the present disclosure will be described below with reference to FIGS. 25 to 28. In this embodiment, for the sake of brevity, some descriptions similar to those in Embodiment 1 will be omitted.

As shown in FIGS. 25 to 27, the lens system 10 includes, sequentially arranged from an object side to an image side along an optical axis, a first right-angle prism P1, a first lens L1, a second lens L2, a third lens L3, a second right-angle prism P2, a third right-angle prism P3, and an imaging plane S18. The folded optical axis includes a first part AX1, a second part AX2, a third part AX3, and a fourth part AX4. The first lens L1, the second lens L2, and the third lens L3 are located on the optical axis AX2.

The first right-angle prism P1 has a light incident surface S1, a reflective surface S2, and a light emergent surface S3.

The first lens L1 has a negative refractive power, and an object side surface S4 and an image side surface S5 thereof are both aspherical. The object side surface S4 is convex at the optical axis and is convex at its circumference, and the image side surface S5 is concave at the optical axis and is concave at its circumference. The second lens L2 has a positive refractive power, and an object side surface S6 and an image side surface S7 thereof are both aspherical. The object side surface S6 is convex at the optical axis and is concave at its circumference, and the image side surface S7 is concave at the optical axis and is convex at its circumference. The third lens L3 has a positive refractive power, and an object side surface S8 and an image side surface S9 thereof are both aspherical. The object side surface S8 is convex at the optical axis and is convex at its circumference, and the image side surface S9 is concave at the optical axis and is concave at its circumference.

The second right-angle prism P2 has a light incident surface S12, a reflective surface S13, and a light emergent surface S14.

The third right-angle prism P3 has a light incident surface S15, a reflective surface S16, and a light emergent surface S17.

The object side surfaces and the image side surfaces of the first lens L1 to the third lens L3 are all configured to be aspherical. The first lens L1 to the third lens L3 are all made of plastic. An optical stop STO is further disposed between the first right-angle prism P1 and the first lens L1. The lens system 10 further includes an infrared filter 110 disposed on an image side of the third lens L3 and having an object side surface S10 and an image side surface S11.

Table 18 shows the surface type, radius of curvature, thickness, material, refractive index, Abbe number (that is, dispersion coefficient), effective focal length, Y-half aperture, and X-half aperture of each of the lenses of the lens system 10 according to Embodiment 7, where the units of the radius of curvature, the thickness, the effective focal length of each of the lenses, the Y-half aperture, and the X-half aperture are all millimeters (mm) Table 19 shows the high-order term coefficients that can be used for the lens aspherical surfaces S4 to S9 in Embodiment 7, where the surface shape of the aspherical surface can be defined by the equation (1) provided in Embodiment 1. Table 20 shows values of relevant parameters of the lens system 10 given in Embodiment 7.

TABLE 18
Embodiment 7
f = 27 mm, FNO = 5.87, HFOV = 4.81°, TTL = 19.71 mm

| Surface | Surface | Surface | Radius of | | | Refractive | Abbe | Focal | Refraction | Y-half | X-half |
|---|---|---|---|---|---|---|---|---|---|---|---|
| number | name | type | curvature | Thickness | Material | index | number | length | mode | aperture | aperture |
| OBJ | Object plane | Spherical | Infinite | Infinite | | | | | Refraction | | |
| S1 | First right- | Spherical | Infinite | −2.500 | Glass | 1.518 | 64.166 | | Refraction | 2.500 | 2.500 |
| S2 | angle prism | Spherical | Infinite | 2.500 | | | | | Reflection | 2.500 | 3.536 |
| S3 | | Spherical | Infinite | 0.700 | | | | | Refraction | 2.500 | 2.500 |
| STO | Optical stop | Spherical | Infinite | 0.100 | | | | | Refraction | 2.300 | 2.300 |
| S4 | First lens | Aspherical | 12.521 | 3.635 | Plastic | 1.546 | 56.114 | −22897.674 | Refraction | 2.327 | 2.327 |
| S5 | | Aspherical | 11.226 | 1.650 | | | | | Refraction | 2.270 | 2.270 |
| S6 | Second lens | Aspherical | 11.318 | 1.664 | Plastic | 1.644 | 23.517 | 1000.038 | Refraction | 2.290 | 2.290 |
| S7 | | Aspherical | 10.857 | 0.559 | | | | | Refraction | 2.513 | 2.513 |
| S8 | Third lens | Aspherical | 6.896 | 3.800 | Plastic | 1.546 | 56.114 | 23.425 | Refraction | 2.614 | 2.614 |
| S9 | | Aspherical | 12.055 | 1.529 | | | | | Refraction | 2.154 | 2.154 |
| S10 | Infrared | Spherical | Infinite | 0.210 | Glass | 1.518 | 64.166 | | Refraction | 2.163 | 2.163 |
| S11 | filter | Spherical | Infinite | 0.919 | | | | | Refraction | 2.164 | 2.164 |
| S12 | Second | Spherical | Infinite | 2.400 | Glass | 1.518 | 64.166 | | Refraction | 2.400 | 2.400 |
| S13 | right-angle | Spherical | Infinite | −2.400 | | | | | Reflection | 3.394 | 2.400 |
| S14 | prism | Spherical | Infinite | −1.740 | | | | | Refraction | 2.400 | 2.400 |
| S15 | Third right- | Spherical | Infinite | −2.550 | Glass | 1.518 | 64.166 | | Refraction | 2.550 | 2.550 |
| S16 | angle prism | Spherical | Infinite | 2.550 | | | | | Reflection | 3.606 | 2.550 |
| S17 | | Spherical | Infinite | 7.483 | | | | | Refraction | 2.550 | 2.550 |
| S18 | Imaging | Spherical | Infinite | 0.000 | | | | | Refraction | 2.285 | 2.285 |
| | plane | | | | | | | | | | |

TABLE 19
Embodiment 7
Aspheric coefficient

| Surface | | | | | | |
|---|---|---|---|---|---|---|
| number | S4 | S5 | S6 | S7 | S8 | S9 |
| K | 0.0000E+00 | 0.0000E+00 | 0.0000E+00 | 0.0000E+00 | 0.0000E+00 | 0.0000E+00 |
| A4 | 5.9000E−04 | 9.4200E−03 | 1.8640E−02 | 5.6100E−03 | −1.3360E−02 | −7.2900E−03 |
| A6 | −1.1000E−04 | −1.1600E−03 | −1.4000E−04 | 1.2100E−03 | 2.6200E−03 | −1.0000E−05 |
| A8 | 0.0000E+00 | 9.0000E−05 | −1.8000E−04 | −2.1000E−04 | −2.6000E−04 | 5.0000E−05 |
| A10 | 0.0000E+00 | −1.0000E−05 | 1.0000E−05 | 1.0000E−05 | 1.0000E−05 | 0.0000E+00 |
| A12 | 0.0000E+00 | 0.0000E+00 | 0.0000E+00 | 0.0000E+00 | 0.0000E+00 | 0.0000E+00 |
| A14 | 0.0000E+00 | 0.0000E+00 | 0.0000E+00 | 0.0000E+00 | 0.0000E+00 | 0.0000E+00 |
| A16 | 0.0000E+00 | 0.0000E+00 | 0.0000E+00 | 0.0000E+00 | 0.0000E+00 | 0.0000E+00 |
| A18 | 0.0000E+00 | 0.0000E+00 | 0.0000E+00 | 0.0000E+00 | 0.0000E+00 | 0.0000E+00 |
| A20 | 0.0000E+00 | 0.0000E+00 | 0.0000E+00 | 0.0000E+00 | 0.0000E+00 | 0.0000E+00 |

TABLE 20
Embodiment 7

| | | | |
|---|---|---|---|
| f (mm) | 27 | f/FNO (mm) | 4.6 |
| FNO | 5.87 | HFOV/TTL (degrees/mm) | 0.244 |
| HFOV (degrees) | 4.81 | TTL/f | 0.73 |
| TTL | 19.71 | CT12/CT23 | 2.953 |
| ImgH | 2.285 | D32/ImgH | 0.943 |

FIG. 28 shows graphs of longitudinal spherical aberration, astigmatism, and distortion of the lens system 10 according to Embodiment 7, respectively. The reference wavelength of the lens system 10 is 555 nm. The graph of longitudinal spherical aberration shows the deviation of the convergent focus of light rays with wavelengths of 470 nm, 510 nm, 555 nm, 610 nm, and 650 nm after passing through the lens system 10. The graph of astigmatism shows the curvature of meridian image plane and the curvature of sagittal image plane of the lens system 10. The graph of distortion shows the distortion of the lens system 10 with different image heights. According to FIG. 28, it can be seen that the lens system 10 provided in Embodiment 7 can achieve good imaging quality.

### Embodiment 8

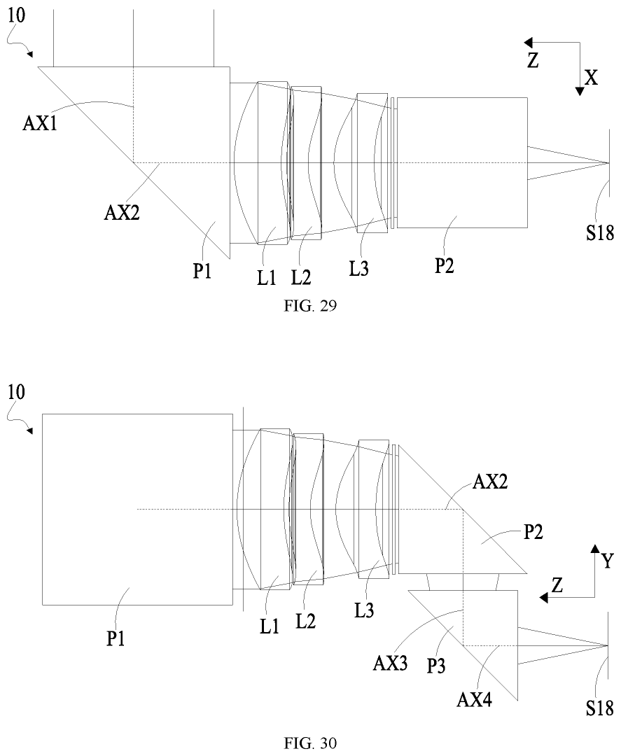

A lens system 10 of Embodiment 8 of the present disclosure will be described below with reference to FIGS. 29 to 32. In this embodiment, for the sake of brevity, some descriptions similar to those in Embodiment 1 will be omitted.

As shown in FIGS. 29 to 31, the lens system 10 includes, sequentially arranged from an object side to an image side along an optical axis, a first right-angle prism P1, a first lens L1, a second lens L2, a third lens L3, a second right-angle prism P2, a third right-angle prism P3, and an imaging plane S18. The folded optical axis includes a first part AX1, a second part AX2, a third part AX3, and a fourth part AX4. The first lens L1, the second lens L2, and the third lens L3 are located on the optical axis AX2.

The first right-angle prism P1 has a light incident surface S1, a reflective surface S2, and a light emergent surface S3.

The first lens L1 has a positive refractive power, and an object side surface S4 and an image side surface S5 thereof are both aspherical. The object side surface S4 is convex at the optical axis and is convex at its circumference, and the image side surface S5 is concave at the optical axis and is convex at its circumference. The second lens L2 has a negative refractive power, and an object side surface S6 and an image side surface S7 thereof are both aspherical. The object side surface S6 is convex at the optical axis and is concave at its circumference, and the image side surface S7 is concave at the optical axis and is convex at its circumference. The third lens L3 has a positive refractive power, and an object side surface S8 and an image side surface S9 thereof are both aspherical. The object side surface S8 is convex at the optical axis and is concave at its circumference, and the image side surface S9 is concave at the optical axis and is convex at its circumference.

The second right-angle prism P2 has a light incident surface S12, a reflective surface S13, and a light emergent surface S14.

The third right-angle prism P3 has a light incident surface S15, a reflective surface S16, and a light emergent surface S17.

The object side surfaces and the image side surfaces of the first lens L1 to the third lens L3 are all configured to be aspherical. The first lens L1 to the third lens L3 are all made of plastic. An optical stop STO is further disposed between the first right-angle prism P1 and the first lens L1. The lens system 10 further includes an infrared filter 110 disposed on an image side of the third lens L3 and having an object side surface S10 and an image side surface S11.

Table 21 shows the surface type, radius of curvature, thickness, material, refractive index, Abbe number (that is, dispersion coefficient), effective focal length, Y-half aperture, and X-half aperture of each of the lenses of the lens system 10 according to Embodiment 8, where the units of the radius of curvature, the thickness, the effective focal length of each of the lenses, the Y-half aperture, and the X-half aperture are all millimeters (mm) Table 22 shows the high-order term coefficients that can be used for the lens aspherical surfaces S4 to S9 in Embodiment 8, where the surface shape of the aspherical surface can be defined by the equation (1) provided in Embodiment 1. Table 23 shows values of relevant parameters of the lens system 10 given in Embodiment 8.

TABLE 21
Embodiment 8
f = 27.14 mm, FNO = 2.5, HFOV = 4.81°, TTL = 16.09 mm

| Surface | Surface | Surface | Radius of | | | Refractive | Abbe | Focal | Refraction | Y-half | X-half |
|---|---|---|---|---|---|---|---|---|---|---|---|
| number | name | type | curvature | Thickness | Material | index | number | length | mode | aperture | aperture |
| OBJ | Object plane | Spherical | Infinite | Infinite | | | | | Refraction | | |
| S1 | First right- | Spherical | Infinite | −6.500 | Glass | 1.518 | 64.166 | | Refraction | 6.500 | 6.500 |
| S2 | angle prism | Spherical | Infinite | 6.500 | | | | | Reflection | 6.500 | 9.192 |
| S3 | | Spherical | Infinite | 0.700 | | | | | Refraction | 6.500 | 6.500 |
| STO | Optical stop | Spherical | Infinite | −0.411 | | | | | Refraction | 5.412 | 5.412 |
| S4 | First lens | Aspherical | 9.035 | 3.201 | Plastic | 1.546 | 56.114 | 49.507 | Refraction | 5.495 | 5.495 |
| S5 | | Aspherical | 11.874 | 0.359 | | | | | Refraction | 5.225 | 5.225 |
| S6 | Second lens | Aspherical | 11.354 | 1.451 | Plastic | 1.644 | 23.517 | −21.847 | Refraction | 5.162 | 5.162 |
| S7 | | Aspherical | 5.969 | 1.747 | | | | | Refraction | 5.153 | 5.153 |
| S8 | Third lens | Aspherical | 5.406 | 2.731 | Plastic | 1.546 | 56.114 | 15.017 | Refraction | 4.713 | 4.713 |
| S9 | | Aspherical | 13.039 | 1.130 | | | | | Refraction | 4.440 | 4.440 |
| S10 | Infrared | Spherical | Infinite | 0.210 | Glass | 1.518 | 64.166 | | Refraction | 4.407 | 4.407 |
| S11 | filter | Spherical | Infinite | 0.202 | | | | | Refraction | 4.391 | 4.391 |
| S12 | Second | Spherical | Infinite | 4.400 | Glass | 1.518 | 64.166 | | Refraction | 4.400 | 4.400 |
| S13 | right-angle | Spherical | Infinite | −4.400 | | | | | Reflection | 6.223 | 4.400 |
| S14 | prism | Spherical | Infinite | −1.132 | | | | | Refraction | 4.400 | 4.400 |
| S15 | Third right- | Spherical | Infinite | −3.750 | Glass | 1.518 | 64.166 | | Refraction | 3.750 | 3.750 |
| S16 | angle prism | Spherical | Infinite | 3.750 | | | | | Reflection | 5.303 | 3.750 |
| S17 | | Spherical | Infinite | 6.187 | | | | | Refraction | 3.750 | 3.750 |
| S18 | Imaging | Spherical | Infinite | 0.000 | | | | | Refraction | 2.287 | 2.287 |
| | plane | | | | | | | | | | |

TABLE 22
Embodiment 8
Aspheric coefficient

| Surface number | S4 | S5 | S6 | S7 | S8 | S9 |
|---|---|---|---|---|---|---|
| K | 0.0000E+00 | 0.0000E+00 | 0.0000E+00 | 0.0000E+00 | 0.0000E+00 | 0.0000E+00 |
| A4 | 2.4000E−04 | −1.7000E−04 | 3.0000E−05 | 1.7000E−03 | 6.0000E−04 | −1.2600E−03 |
| A6 | 0.0000E+00 | 1.0000E−04 | 1.2000E−04 | 1.0000E−04 | 3.0000E−05 | −1.0000E−05 |
| A8 | 0.0000E+00 | 0.0000E+00 | −1.0000E−05 | 0.0000E+00 | 0.0000E+00 | 1.0000E−05 |
| A10 | 0.0000E+00 | 0.0000E+00 | 0.0000E+00 | 0.0000E+00 | 0.0000E+00 | 0.0000E+00 |
| A12 | 0.0000E+00 | 0.0000E+00 | 0.0000E+00 | 0.0000E+00 | 0.0000E+00 | 0.0000E+00 |
| A14 | 0.0000E+00 | 0.0000E+00 | 0.0000E+00 | 0.0000E+00 | 0.0000E+00 | 0.0000E+00 |
| A16 | 0.0000E+00 | 0.0000E+00 | 0.0000E+00 | 0.0000E+00 | 0.0000E+00 | 0.0000E+00 |
| A18 | 0.0000E+00 | 0.0000E+00 | 0.0000E+00 | 0.0000E+00 | 0.0000E+00 | 0.0000E+00 |
| A20 | 0.0000E+00 | 0.0000E+00 | 0.0000E+00 | 0.0000E+00 | 0.0000E+00 | 0.0000E+00 |

TABLE 23
Embodiment 8

| | | | |
|---|---|---|---|
| f (mm) | 27.14 | f/FNO (mm) | 10.855 |
| FNO | 2.5 | HFOV/TTL (degrees/mm) | 0.299 |
| HFOV (degrees) | 4.81 | TTL/f | 0.593 |
| TTL | 16.09 | CT12/CT23 | 0.206 |
| ImgH | 2.287 | D32/ImgH | 1.067 |

FIG. 32 shows graphs of longitudinal spherical aberration, astigmatism, and distortion of the lens system 10 according to Embodiment 8, respectively. The reference wavelength of the lens system 10 is 555 nm. The graph of longitudinal spherical aberration shows the deviation of the convergent focus of light rays with wavelengths of 470 nm, 510 nm, 555 nm, 610 nm, and 650 nm after passing through the lens system 10. The graph of astigmatism shows the curvature of meridian image plane and the curvature of sagittal image plane of the lens system 10. The graph of distortion shows the distortion of the lens system 10 with different image heights. According to FIG. 32, it can be seen that the lens system 10 provided in Embodiment 8 can achieve good imaging quality.

### Embodiment 9

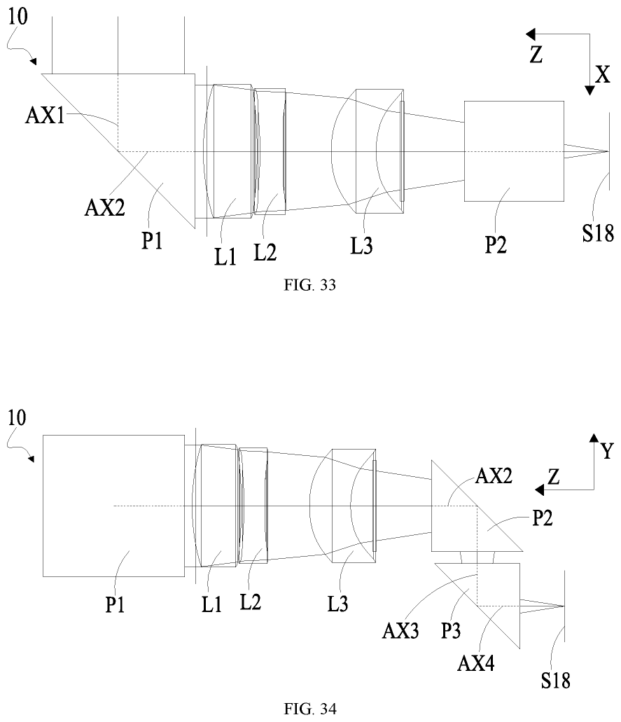

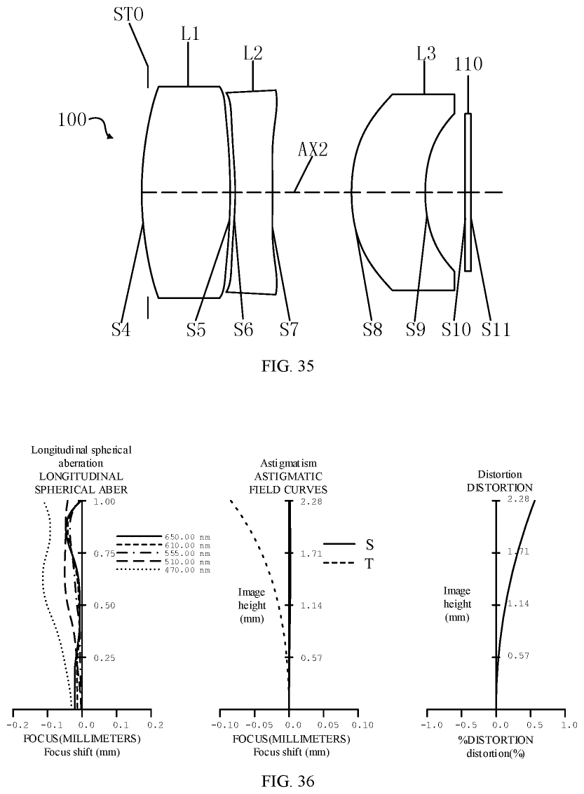

A lens system 10 of Embodiment 9 of the present disclosure will be described below with reference to FIGS. 33 to 36. In this embodiment, for the sake of brevity, some descriptions similar to those in Embodiment 1 will be omitted.

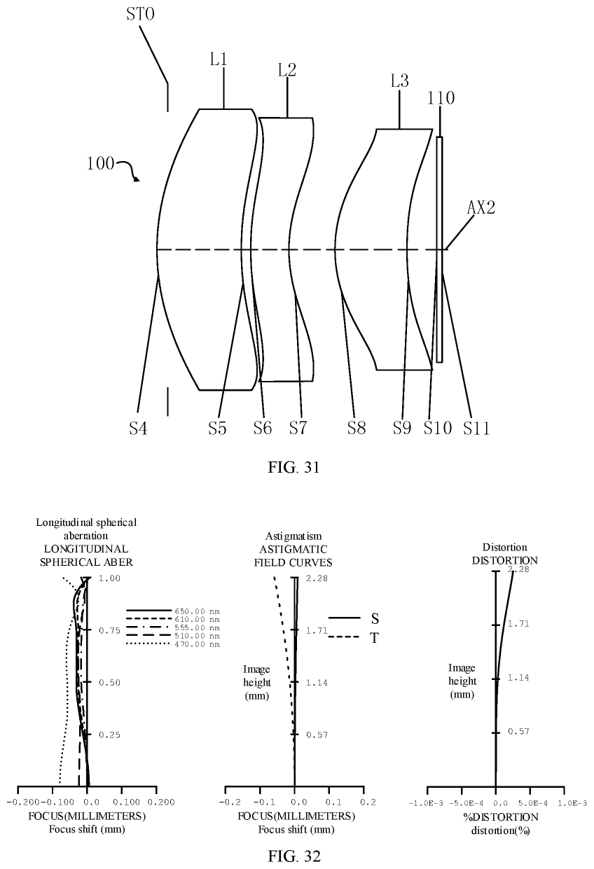

As shown in FIGS. 31 to 35, the lens system 10 includes, sequentially arranged from an object side to an image side along an optical axis, a first right-angle prism P1, a first lens L1, a second lens L2, a third lens L3, a second right-angle prism P2, a third right-angle prism P3, and an imaging plane S18. The folded optical axis includes a first part AX1, a second part AX2, a third part AX3, and a fourth part AX4. The first lens L1, the second lens L2, and the third lens L3 are located on the optical axis AX2.

The first right-angle prism P1 has a light incident surface S1, a reflective surface S2, and a light emergent surface S3.

The first lens L1 has a positive refractive power, and an object side surface S4 and an image side surface S5 thereof are both aspherical. The object side surface S4 is convex at the optical axis and is convex at its circumference, and the image side surface S5 is convex at the optical axis and is convex at its circumference. The second lens L2 has a negative refractive power, and an object side surface S6 and an image side surface S7 thereof are both aspherical. The object side surface S6 is concave at the optical axis and is concave at its circumference, and the image side surface S7 is convex at the optical axis and is convex at its circumference. The third lens L3 has a negative refractive power, and an object side surface S8 and an image side surface S9 thereof are both aspherical. The object side surface S8 is convex at the optical axis and is concave at its circumference, and the image side surface S9 is concave at the optical axis and is concave at its circumference.

The second right-angle prism P2 has a light incident surface S12, a reflective surface S13, and a light emergent surface S14.

The third right-angle prism P3 has a light incident surface S15, a reflective surface S16, and a light emergent surface S17.

The object side surfaces and the image side surfaces of the first lens L1 to the third lens L3 are all configured to be aspherical. The first lens L1 to the third lens L3 are all made of plastic. An optical stop STO is further disposed between the first right-angle prism P1 and the first lens L1. The lens system 10 further includes an infrared filter 110 disposed on an image side of the third lens L3 and having an object side surface S10 and an image side surface S11.

Table 24 shows the surface type, radius of curvature, thickness, material, refractive index, Abbe number (that is, dispersion coefficient), effective focal length, Y-half aperture, and X-half aperture of each of the lenses of the lens system 10 according to Embodiment 9, where the units of the radius of curvature, the thickness, the effective focal length of each of the lenses, the Y-half aperture, and the X-half aperture are all millimeters (mm) Table 25 shows the high-order term coefficients that can be used for the lens aspherical surfaces S4 to S9 in Embodiment 9, where the surface shape of the aspherical surface can be defined by the equation (1) provided in Embodiment 1. Table 26 shows values of relevant parameters of the lens system 10 given in Embodiment 9.

TABLE 24
Embodiment 9
f = 25.76 mm, FNO = 3.3, HFOV = 5.03°, TTL = 17.54 mm

| Surface | Surface | Surface | Radius of | | | Refractive | Abbe | Focal | Refraction | Y-half | X-half |
|---|---|---|---|---|---|---|---|---|---|---|---|
| number | name | type | curvature | Thickness | Material | index | number | length | mode | aperture | aperture |
| OBJ | Object | Spherical | Infinite | Infinite | | | | | Refraction | | |
| | plane | | | | | | | | | | |
| S1 | First right- | Spherical | Infinite | −4.550 | Glass | 1.518 | 64.166 | | Refraction | 4.550 | 4.550 |
| S2 | angle | Spherical | Infinite | 4.550 | | | | | Reflection | 4.550 | 6.435 |
| S3 | prism | Spherical | Infinite | 0.700 | | | | | Refraction | 4.550 | 4.550 |
| STO | Optical | Spherical | Infinite | −0.225 | | | | | Refraction | 3.903 | 3.903 |
| | stop | | | | | | | | | | |
| S4 | First | Aspherical | 12.772 | 3.184 | Plastic | 1.546 | 56.114 | 15.716 | Refraction | 3.937 | 3.937 |
| S5 | lens | Aspherical | −23.836 | 0.183 | | | | | Refraction | 3.767 | 3.767 |
| S6 | Second | Aspherical | −11.814 | 1.350 | Plastic | 1.644 | 23.517 | −31.524 | Refraction | 3.710 | 3.710 |
| S7 | lens | Aspherical | −29.521 | 2.841 | | | | | Refraction | 3.804 | 3.804 |
| S8 | Third | Aspherical | 7.141 | 2.653 | Plastic | 1.546 | 56.114 | −075.779 | Refraction | 3.647 | 3.647 |
| S9 | lens | Aspherical | 6.177 | 1.435 | | | | | Refraction | 2.946 | 2.946 |
| S10 | Infrared | Spherical | Infinite | 0.210 | Glass | 1.518 | 64.166 | | Refraction | 2.930 | 2.930 |
| S11 | filter | Spherical | Infinite | 3.557 | | | | | Refraction | 2.924 | 2.924 |
| S12 | Second | Spherical | Infinite | 2.950 | Glass | 1.518 | 64.166 | | Refraction | 2.950 | 2.950 |
| S13 | right-angle | Spherical | Infinite | −2.950 | | | | | Reflection | 4.172 | 2.950 |
| S14 | prism | Spherical | Infinite | −0.746 | | | | | Refraction | 2.950 | 2.950 |
| S15 | Third | Spherical | Infinite | −2.750 | Glass | 1.518 | 64.166 | | Refraction | 2.750 | 2.750 |
| S16 | right-angle | Spherical | Infinite | 2.750 | | | | | Reflection | 3.889 | 2.750 |
| S17 | prism | Spherical | Infinite | 2.870 | | | | | Refraction | 2.750 | 2.750 |
| S18 | Imaging | Spherical | Infinite | 0.000 | | | | | Refraction | 2.290 | 2.290 |
| | plane | | | | | | | | | | |

TABLE 25
Embodiment 9
Aspheric coefficient

| Surface | | | | | | |
|---|---|---|---|---|---|---|
| number | S4 | S5 | S6 | S7 | S8 | S9 |
| K | 0.0000E+00 | 0.0000E+00 | 0.0000E+00 | 0.0000E+00 | 0.0000E+00 | 0.0000E+00 |
| A4 | 3.5000E−04 | −1.1000E−03 | −6.6100E−03 | −6.8800E−03 | −4.4700E−03 | −4.1100E−03 |
| A6 | 1.0000E−05 | 3.6000E−04 | 7.4000E−04 | 3.7000E−04 | 1.6000E−04 | −1.1000E−04 |
| A8 | 0.0000E+00 | −5.0000E−05 | −6.0000E−05 | 0.0000E+00 | −1.0000E−05 | 0.0000E+00 |
| A10 | 0.0000E+00 | 0.0000E+00 | 0.0000E+00 | 0.0000E+00 | 0.0000E+00 | 0.0000E+00 |
| A12 | 0.0000E+00 | 0.0000E+00 | 0.0000E+00 | 0.0000E+00 | 0.0000E+00 | 0.0000E+00 |
| A14 | 0.0000E+00 | 0.0000E+00 | 0.0000E+00 | 0.0000E+00 | 0.0000E+00 | 0.0000E+00 |
| A16 | 0.0000E+00 | 0.0000E+00 | 0.0000E+00 | 0.0000E+00 | 0.0000E+00 | 0.0000E+00 |
| A18 | 0.0000E+00 | 0.0000E+00 | 0.0000E+00 | 0.0000E+00 | 0.0000E+00 | 0.0000E+00 |
| A20 | 0.0000E+00 | 0.0000E+00 | 0.0000E+00 | 0.0000E+00 | 0.0000E+00 | 0.0000E+00 |

TABLE 26
Embodiment 9

| | | | |
|---|---|---|---|
| f (mm) | 25.76 | f/FNO (mm) | 7.806 |
| FNO | 3.3 | HFOV/TTL (degrees/mm) | 0.287 |
| HFOV (degrees) | 5.03 | TTL/f | 0.681 |
| TTL | 17.54 | CT12/CT23 | 0.064 |
| ImgH | 2.290 | D32/ImgH | 1.287 |

FIG. 36 shows graphs of longitudinal spherical aberration, astigmatism, and distortion of the lens system 10 according to Embodiment 9, respectively. The reference wavelength of the lens system 10 is 555 nm. The graph of longitudinal spherical aberration shows the deviation of the convergent focus of light rays with wavelengths of 470 nm, 510 nm, 555 nm, 610 nm, and 650 nm after passing through the lens system 10. The graph of astigmatism shows the curvature of meridian image plane and the curvature of sagittal image plane of the lens system 10. The graph of distortion shows the distortion of the lens system 10 with different image heights. According to FIG. 36, it can be seen that the lens system 10 provided in Embodiment 9 can achieve good imaging quality.

### Embodiment 10

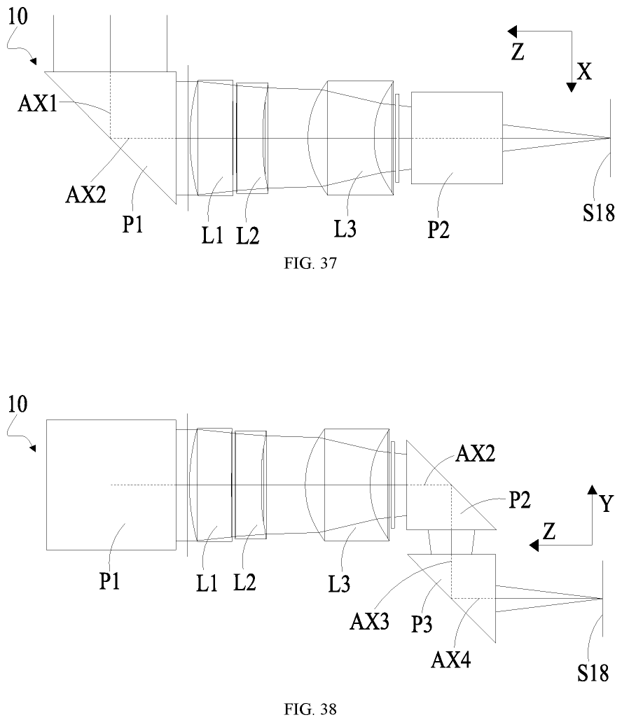

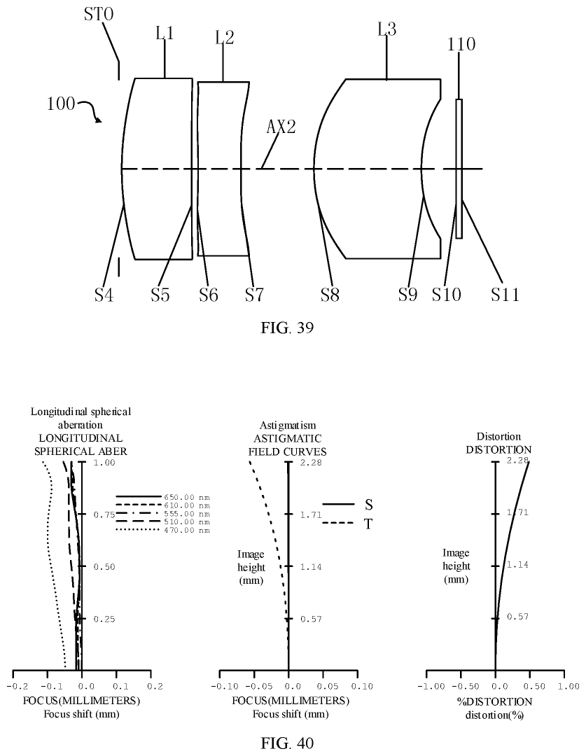

A lens system 10 of Embodiment 10 of the present disclosure will be described below with reference to FIGS. 37 to 40. In this embodiment, for the sake of brevity, some descriptions similar to those in Embodiment 1 will be omitted.

As shown in FIGS. 37 to 39, the lens system 10 includes, sequentially arranged from an object side to an image side along an optical axis, a first right-angle prism P1, a first lens L1, a second lens L2, a third lens L3, a second right-angle prism P2, a third right-angle prism P3, and an imaging plane S18. The folded optical axis includes a first part AX1, a second part AX2, a third part AX3, and a fourth part AX4. The first lens L1, the second lens L2, and the third lens L3 are located on the optical axis AX2.

The first right-angle prism P1 has a light incident surface S1, a reflective surface S2, and a light emergent surface S3.

The first lens L1 has a positive refractive power, and an object side surface S4 and an image side surface S5 thereof are both aspherical. The object side surface S4 is convex at the optical axis and is convex at its circumference, and the image side surface S5 is concave at the optical axis and is convex at its circumference. The second lens L2 has a negative refractive power, and an object side surface S6 and an image side surface S7 thereof are both aspherical. The object side surface S6 is concave at the optical axis and is concave at its circumference, and the image side surface S7 is concave at the optical axis and is convex at its circumference. The third lens L3 has a positive refractive power, and an object side surface S8 and an image side surface S9 thereof are both aspherical. The object side surface S8 is convex at the optical axis and is convex at its circumference, and the image side surface S9 is concave at the optical axis and is concave at its circumference.

The second right-angle prism P2 has a light incident surface S12, a reflective surface S13, and a light emergent surface S14.

The third right-angle prism P3 has a light incident surface S15, a reflective surface S16, and a light emergent surface S17.

The object side surfaces and the image side surfaces of the first lens L1 to the third lens L3 are all configured to be aspherical. The first lens L1 to the third lens L3 are all made of plastic. An optical stop STO is further disposed between the first right-angle prism P1 and the first lens L1. The lens system 10 further includes an infrared filter 110 disposed on an image side of the third lens L3 and having an object side surface S10 and an image side surface S11.

Table 27 shows the surface type, radius of curvature, thickness, material, refractive index, Abbe number (that is, dispersion coefficient), effective focal length, Y-half aperture, and X-half aperture of each of the lenses of the lens system 10 according to Embodiment 10, where the units of the radius of curvature, the thickness, the effective focal length of each of the lenses, the Y-half aperture, and the X-half aperture are all millimeters (mm) Table 28 shows the high-order term coefficients that can be used for the lens aspherical surfaces S4 to S9 in Embodiment 10, where the surface shape of the aspherical surface can be defined by the equation (1) provided in Embodiment 1. Table 29 shows values of relevant parameters of the lens system 10 given in Embodiment 10.

TABLE 27
Embodiment 10
f = 27.4 mm, FNO = 4.1, HFOV = 4.74°, TTL = 18.02 mm

| Surface | Surface | Surface | Radius of | | | Refractive | Abbe | Focal | Refraction | Y-half | X-half |
|---|---|---|---|---|---|---|---|---|---|---|---|
| number | name | type | curvature | Thickness | Material | index | number | length | mode | aperture | aperture |
| OBJ | Object plane | Spherical | Infinite | Infinite | | | | | Refraction | | |
| S1 | First right- | Spherical | Infinite | −3.900 | Glass | 1.518 | 64.166 | | Refraction | 3.900 | 3.900 |
| S2 | angle prism | Spherical | Infinite | 3.900 | | | | | Reflection | 3.900 | 5.515 |
| S3 | | Spherical | Infinite | 0.700 | | | | | Refraction | 3.900 | 3.900 |
| STO | Optical stop | Spherical | Infinite | 0.100 | | | | | Refraction | 3.342 | 3.342 |
| S4 | First lens | Aspherical | 11.057 | 2.532 | Plastic | 1.546 | 56.114 | 22.212 | Refraction | 3.390 | 3.390 |
| S5 | | Aspherical | 115.264 | 0.243 | | | | | Refraction | 3.272 | 3.272 |
| S6 | Second lens | Aspherical | −21.810 | 1.550 | Plastic | 1.644 | 23.517 | −29.421 | Refraction | 3.254 | 3.254 |
| S7 | | Aspherical | 148.398 | 2.651 | | | | | Refraction | 3.257 | 3.257 |
| S8 | Third lens | Aspherical | 6.033 | 3.900 | Plastic | 1.546 | 56.114 | 45.000 | Refraction | 3.356 | 3.356 |
| S9 | | Aspherical | 6.171 | 1.261 | | | | | | | |
| S10 | Infrared | Spherical | Infinite | 0.210 | Glass | 1.518 | 64.166 | | Refraction | 2.602 | 2.602 |
| S11 | filter | Spherical | Infinite | 0.722 | | | | | Refraction | 2.599 | 2.599 |
| S12 | Second | Spherical | Infinite | 2.700 | Glass | 1.518 | 64.166 | | Refraction | 2.700 | 2.700 |
| S13 | right-angle | Spherical | Infinite | −2.700 | | | | | Reflection | 3.818 | 2.700 |
| S14 | prism | Spherical | Infinite | −1.476 | | | | | Refraction | 2.700 | 2.700 |
| S15 | Third right- | Spherical | Infinite | −2.650 | Glass | 1.518 | 64.166 | | Refraction | 2.650 | 2.650 |
| S16 | angle prism | Spherical | Infinite | 2.650 | | | | | Reflection | 3.748 | 2.650 |
| S17 | | Spherical | Infinite | 6.424 | | | | | Refraction | 2.650 | 2.650 |
| S18 | Imaging | Spherical | Infinite | 0.000 | | | | | Refraction | 2.285 | 2.285 |
| | plane | | | | | | | | | | |

TABLE 28
Embodiment 10
Aspheric coefficient

| Surface | | | | | | |
|---|---|---|---|---|---|---|
| number | S4 | S5 | S6 | S7 | S8 | S9 |
| K | 0.0000E+00 | 0.0000E+00 | 0.0000E+00 | 0.0000E+00 | 0.0000E+00 | 0.0000E+00 |
| A4 | 6.9000E−04 | −1.3000E−04 | −6.3200E−03 | −7.2800E−03 | −2.7700E−03 | −2.7600E−03 |
| A6 | 1.0000E−05 | 2.9000E−04 | 7.2000E−04 | 4.5000E−04 | 1.8000E−04 | −5.0000E−05 |
| A8 | 0.0000E+00 | −5.0000E−05 | −6.0000E−05 | 1.0000E−05 | −1.0000E−05 | 1.0000E−05 |
| A10 | 0.0000E+00 | 0.0000E+00 | 0.0000E+00 | 0.0000E+00 | 0.0000E+00 | 0.0000E+00 |
| A12 | 0.0000E+00 | 0.0000E+00 | 0.0000E+00 | 0.0000E+00 | 0.0000E+00 | 0.0000E+00 |
| A14 | 0.0000E+00 | 0.0000E+00 | 0.0000E+00 | 0.0000E+00 | 0.0000E+00 | 0.0000E+00 |
| A16 | 0.0000E+00 | 0.0000E+00 | 0.0000E+00 | 0.0000E+00 | 0.0000E+00 | 0.0000E+00 |
| A18 | 0.0000E+00 | 0.0000E+00 | 0.0000E+00 | 0.0000E+00 | 0.0000E+00 | 0.0000E+00 |
| A20 | 0.0000E+00 | 0.0000E+00 | 0.0000E+00 | 0.0000E+00 | 0.0000E+00 | 0.0000E+00 |

TABLE 29
Embodiment 10

| | | | |
|---|---|---|---|
| f (mm) | 27.4 | f/FNO (mm) | 6.684 |
| FNO | 4.1 | HFOV/TTL (degrees/mm) | 0.263 |
| HFOV (degrees) | 4.74 | TTL/f | 0.657 |
| TTL | 18.02 | CT12/CT23 | 0.092 |
| ImgH | 2.285 | D32/ImgH | 1.144 |

FIG. 40 shows graphs of longitudinal spherical aberration, astigmatism, and distortion of the lens system 10 according to Embodiment 10, respectively. The reference wavelength of the lens system 10 is 555 nm. The graph of longitudinal spherical aberration shows the deviation of the convergent focus of light rays with wavelengths of 470 nm, 510 nm, 555 nm, 610 nm, and 650 nm after passing through the lens system 10. The graph of astigmatism shows the curvature of meridian image plane and the curvature of sagittal image plane of the lens system 10. The graph of distortion shows the distortion of the lens system 10 with different image heights. According to FIG. 40, it can be seen that the lens system 10 provided in Embodiment 10 can achieve good imaging quality.

### Embodiment 11

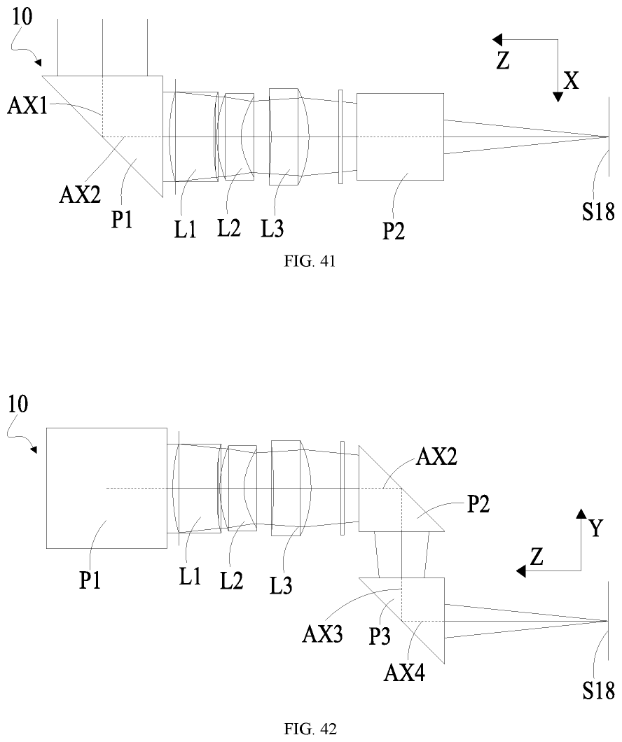

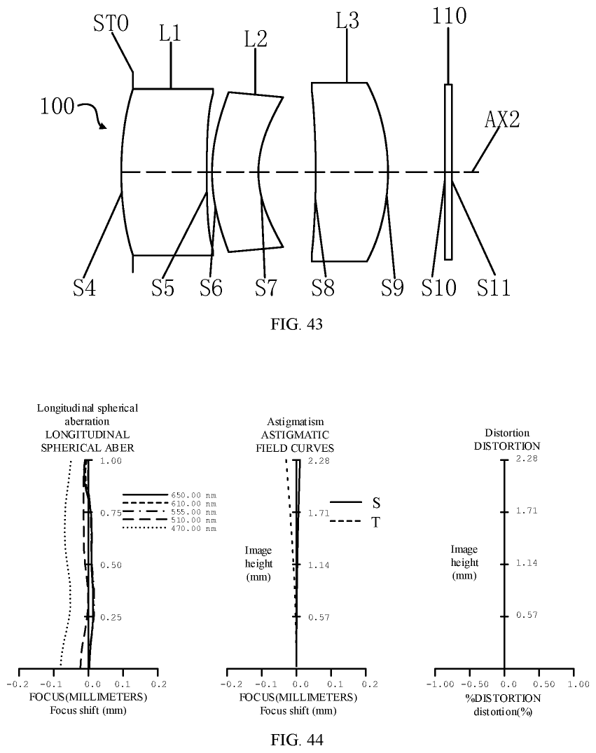

A lens system 10 of Embodiment 11 of the present disclosure will be described below with reference to FIGS. 41 to 44. In this embodiment, for the sake of brevity, some descriptions similar to those in Embodiment 1 will be omitted.

As shown in FIGS. 41 to 43, the lens system 10 includes, sequentially arranged from an object side to an image side along an optical axis, a first right-angle prism P1, a first lens L1, a second lens L2, a third lens L3, a second right-angle prism P2, a third right-angle prism P3, and an imaging plane S18. The folded optical axis includes a first part AX1, a second part AX2, a third part AX3, and a fourth part AX4. The first lens L1, the second lens L2, and the third lens L3 are located on the optical axis AX2.

The first right-angle prism P1 has a light incident surface S1, a reflective surface S2, and a light emergent surface S3.

The first lens L1 has a positive refractive power, and an object side surface S4 and an image side surface S5 thereof are both aspherical. The object side surface S4 is convex at the optical axis and is convex at its circumference, and the image side surface S5 is concave at the optical axis and is concave at its circumference. The second lens L2 has a negative refractive power, and an object side surface S6 and an image side surface S7 thereof are both aspherical. The object side surface S6 is convex at the optical axis and is concave at its circumference, and the image side surface S7 is concave at the optical axis and is convex at its circumference. The third lens L3 has a positive refractive power, and an object side surface S8 and an image side surface S9 thereof are both aspherical. The object side surface S8 is concave at the optical axis and is concave at its circumference, and the image side surface S9 is convex at the optical axis and is convex at its circumference.

The second right-angle prism P2 has a light incident surface S12, a reflective surface S13, and a light emergent surface S14.

The third right-angle prism P3 has a light incident surface S15, a reflective surface S16, and a light emergent surface S17.

The object side surfaces and the image side surfaces of the first lens L1 to the third lens L3 are all configured to be aspherical. The first lens L1 to the third lens L3 are all made of plastic. An optical stop STO is further disposed between the first right-angle prism P1 and the first lens L1. The lens system 10 further includes an infrared filter 110 disposed on an image side of the third lens L3 and having an object side surface S10 and an image side surface S11.

Table 30 shows the surface type, radius of curvature, thickness, material, refractive index, Abbe number (that is, dispersion coefficient), effective focal length, Y-half aperture, and X-half aperture of each of the lenses of the lens system 10 according to Embodiment 11, where the units of the radius of curvature, the thickness, the effective focal length of each of the lenses, the Y-half aperture, and the X-half aperture are all millimeters (mm) Table 31 shows the high-order term coefficients that can be used for the lens aspherical surfaces S4 to S9 in Embodiment 11, where the surface shape of the aspherical surface can be defined by the equation (1) provided in Embodiment 1. Table 32 shows values of relevant parameters of the lens system 10 given in Embodiment 11.

TABLE 30
Embodiment 11
f = 25.3 mm, FNO = 4.9, HFOV = 5.16°, TTL = 17.64 mm

| Surface | Surface | Surface | Radius of | | | Refractive | Abbe | Focal | Refraction | Y-half | X-half |
|---|---|---|---|---|---|---|---|---|---|---|---|
| number | name | type | curvature | Infinite | Material | index | number | length | mode | aperture | aperture |
| OBJ | Object | Spherical | Infinite | | | | | | Refraction | | |
| | plane | | | | | | | | | | |
| S1 | First right- | Spherical | Infinite | −3.500 | Glass | 1.518 | 64.166 | | Refraction | 3.500 | 3.500 |
| S2 | angle | Spherical | Infinite | 3.500 | | | | | Reflection | 3.500 | 4.950 |
| S3 | prism | Spherical | Infinite | 0.700 | | | | | Refraction | 3.500 | 3.500 |
| STO | Optical | Spherical | Infinite | −0.348 | | | | | Refraction | 2.582 | 2.582 |
| | stop | | | | | | | | | | |
| S4 | First lens | Aspherical | 10.935 | 2.582 | Plastic | 1.546 | 56.114 | 23.851 | Refraction | 2.582 | 2.582 |
| S5 | | Aspherical | 62.580 | 0.158 | | | | | Refraction | 2.450 | 2.450 |
| S6 | Second | Aspherical | 5.690 | 1.400 | Plastic | 1.644 | 23.517 | −14.877 | Refraction | 2.480 | 2.480 |
| S7 | lens | Aspherical | 3.226 | 1.731 | | | | | Refraction | 2.322 | 2.322 |
| S8 | Third lens | Aspherical | −24.107 | 2.180 | Plastic | 1.546 | 56.114 | 16.076 | Refraction | 2.491 | 2.491 |
| S9 | | Aspherical | −6.640 | 1.715 | | | | | Refraction | 2.770 | 2.770 |
| S10 | Infrared | Spherical | Infinite | 0.210 | Glass | 1.518 | 64.166 | | Refraction | 2.717 | 2.717 |
| S11 | filter | Spherical | Infinite | 0.853 | | | | | Refraction | 2.714 | 2.714 |
| S12 | Second | Spherical | Infinite | 2.500 | Glass | 1.518 | 64.166 | | Refraction | 2.500 | 2.500 |
| S13 | right-angle | Spherical | Infinite | −2.500 | | | | | Reflection | 3.536 | 2.500 |
| S14 | prism | Spherical | Infinite | −2.707 | | | | | Refraction | 2.500 | 2.500 |
| S15 | Third | Spherical | Infinite | −2.500 | Glass | 1.518 | 64.166 | | Refraction | 2.500 | 2.500 |
| S16 | right-angle | Spherical | Infinite | 2.500 | | | | | Reflection | 3.536 | 2.500 |
| S17 | prism | Spherical | Infinite | 9.515 | | | | | Refraction | 2.500 | 2.500 |
| S18 | Imaging | Spherical | Infinite | 0.000 | | | | | Refraction | 2.285 | 2.285 |
| | plane | | | | | | | | | | |

TABLE 31
Embodiment 11
Aspheric coefficient

| Surface | | | | | | |
|---|---|---|---|---|---|---|
| number | S4 | S5 | S6 | S7 | S8 | S9 |
| K | 0.0000E+00 | 0.0000E+00 | 0.0000E+00 | 0.0000E+00 | 0.0000E+00 | 0.0000E+00 |
| A4 | −7.4000E−04 | −4.7400E−03 | −5.3000E−04 | 4.0600E−03 | −1.9800E−03 | −7.0000E−05 |
| A6 | −5.0000E−05 | 6.3000E−04 | 1.0900E−03 | 1.4700E−03 | 3.6000E−04 | 8.0000E−05 |
| A8 | 0.0000E+00 | −1.5000E−04 | −2.0000E−04 | −2.2000E−04 | −1.0000E−05 | 0.0000E+00 |
| A10 | 0.0000E+00 | 1.0000E−05 | 1.0000E−05 | 2.0000E−05 | 0.0000E+00 | 0.0000E+00 |
| A12 | 0.0000E+00 | 0.0000E+00 | 0.0000E+00 | 0.0000E+00 | 0.0000E+00 | 0.0000E+00 |
| A14 | 0.0000E+00 | 0.0000E+00 | 0.0000E+00 | 0.0000E+00 | 0.0000E+00 | 0.0000E+00 |
| A16 | 0.0000E+00 | 0.0000E+00 | 0.0000E+00 | 0.0000E+00 | 0.0000E+00 | 0.0000E+00 |
| A18 | 0.0000E+00 | 0.0000E+00 | 0.0000E+00 | 0.0000E+00 | 0.0000E+00 | 0.0000E+00 |
| A20 | 0.0000E+00 | 0.0000E+00 | 0.0000E+00 | 0.0000E+00 | 0.0000E+00 | 0.0000E+00 |

TABLE 32
Embodiment 11

| | | | |
|---|---|---|---|
| f (mm) | 25.3 | f/FNO (mm) | 5.163 |
| FNO | 4.9 | HFOV/TTL (degrees/mm) | 0.293 |
| HFOV (degrees) | 5.16 | TTL/f | 0.697 |
| TTL | 17.64 | CT12/CT23 | 0.091 |
| ImgH | 2.285 | D32/ImgH | 1.212 |

FIG. 44 shows graphs of longitudinal spherical aberration, astigmatism, and distortion of the lens system 10 according to Embodiment 11, respectively. The reference wavelength of the lens system 10 is 555 nm. The graph of longitudinal spherical aberration shows the deviation of the convergent focus of light rays with wavelengths of 470 nm, 510 nm, 555 nm, 610 nm, and 650 nm after passing through the lens system 10. The graph of astigmatism shows the curvature of meridian image plane and the curvature of sagittal image plane of the lens system 10. The graph of distortion shows the distortion of the lens system 10 with different image heights. According to FIG. 44, it can be seen that the lens system 10 provided in Embodiment 11 can achieve good imaging quality.

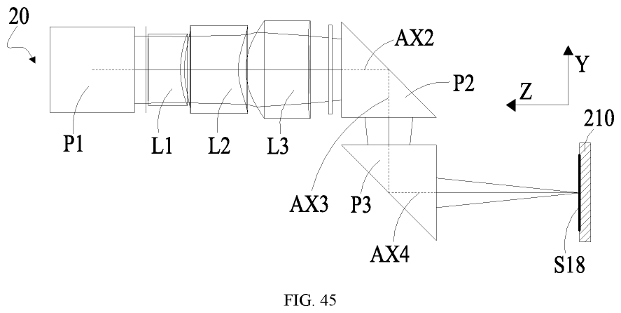

As shown in FIG. 45, the present disclosure further provides an imaging module 20, which includes the lens system 10 as described above and a photosensitive element 210. The photosensitive element 210 is disposed on the image side of the lens system 10. A photosensitive surface of the photosensitive element 210 coincides with the imaging plane S18. Specifically, the photosensitive element 210 may adopt a complementary metal oxide semiconductor (CMOS) image sensor or a charge-coupled device (CCD) image sensor.

The above imaging module 20 can be arranged in a transverse direction of the electronic product, so as to be conveniently adapted to devices with limited size, such as thin and light electronic equipment. In addition, the imaging module 20 further has a long focal length, which can clearly image the distant objects, thereby better meeting the needs of long-distance shooting of mobile phones and tablets.

In some other embodiments, each optical element and the photosensitive element 210 in the imaging module 20 may also be respectively provided with a driving element to drive the corresponding optical element and the photosensitive element 210 to focus the light rays onto the imaging plane, thereby achieving at least one of the zoom, focusing, or anti-shake functions of the imaging module 20.

The present disclosure further provides an electronic device, which includes a housing and the imaging module 20 as described above, and the imaging module 20 is mounted on the housing. Specifically, the imaging module 20 is disposed inside the housing and exposed from the housing to acquire images. The housing can provide protections of dustproof, waterproof, and drop resistance for the imaging module 20. The housing is provided with an opening corresponding to the imaging module 20 to allow light rays to penetrate into or out of the housing through the opening.

The above described electronic device has the characteristics of light and thin structure, and also has a strong telephoto capability, which can improve the shooting experience of a user.

In some other embodiments, the “electronic device” used may further include, but is not limited to, a device configured to be connected via a wired line and/or to receive or send a communication signal via a wireless interface. An electronic device configured to communicate through a wireless interface may be referred to as a “wireless communication terminal”, a “wireless terminal”, or a “mobile terminal”. Examples of the mobile terminal include, but are not limited to a satellite or cellular phone; a personal communication system (PCS) terminal that can combine a cellular radio phone with data processing, fax, and data communication capabilities; a personal digital assistant (PDA) that can include a radio phone, a pager, an Internet/Intranet access, a Web browser, a memo pad, and/or a global positioning system (GPS) receiver; and a conventional laptop and/or handheld receiver or other electronic device including a radio telephone transceiver.

The technical features of the above described embodiments can be combined arbitrarily. To simplify the description, not all possible combinations of the technical features in the above embodiments are described. However, all of the combinations of these technical features should be considered as within the scope of the present disclosure, as long as such combinations do not contradict with each other.

The above described embodiments merely represent several embodiments of the present disclosure, and the description thereof is more specific and detailed, but it should not be construed as limiting the scope of the present disclosure. It should be noted that for those of ordinary skill in the art, without departing from the concept of this disclosure, several modifications and improvements can be further made, which are all within the protection scope of the present disclosure. Therefore, the protection scope of the present disclosure shall be subject to the appended claims.

What is claimed is:

1. A lens system, comprising a plurality of optical elements arranged along a folded optical axis of the lens system, and the plurality of optical elements comprising sequentially from an object side to an image side:
a first optical path folding element, located on a first part of the folded optical axis, the first optical path folding element being configured to direct light from the first part of the folded optical axis to a second part of the folded optical axis;
a lens group, located on the second part of the folded optical axis;
a second optical path folding element, configured to direct light from the second part of the folded optical axis to a third part of the folded optical axis; and
a third optical path folding element, configured to direct light from the third part of the folded optical axis to a fourth part of the folded optical axis;
wherein the second part, the third part, and the fourth part of the folded optical axis are located within a same plane, and the plane is perpendicular to the first part of the folded optical axis.

2. The lens system according to claim 1, wherein at least one of the first optical path folding element, the second optical path folding element, and the third optical path folding element is a prism.

3. The lens system according to claim 1, wherein the lens group comprises sequentially from the object side to the image side along the second part of the folded optical axis:
a first lens having a refractive power;
a second lens having a refractive power; and
a third lens having a refractive power;
wherein an object side surface and/or an image side surface of at least one lens of the first lens to the third lens are aspherical, and at least one surface of the object side surface and the image side surface of the at least one lens has at least one inflection point.

4. The lens system according to claim 3, wherein the lens system satisfies the following relation:
3 mm<f/FNO<12 mm;
wherein, f represents an effective focal length of the lens system, and FNO represents an f-number of the lens system.

5. The lens system according to claim 3, wherein the lens system satisfies the following relation:
HFOV/TTL>0.1 degrees/mm;
wherein, HFOV represents a half field of view of the lens system in a diagonal direction, and TTL represents a distance on the folded optical axis from an object side surface of the first lens to an imaging plane of the lens system.

6. The lens system according to claim 3, wherein the lens system satisfies the following relation:
TTL/f<1.2;
wherein, TTL represents a distance on the folded optical axis from an object side surface of the first lens to an imaging plane of the lens system, and f represents an effective focal length of the lens system.

7. The lens system according to claim 3, wherein the lens system satisfies the following relation:
f>15 mm;
wherein, f represents an effective focal length of the lens system.

8. The lens system according to claim 3, wherein the lens system satisfies the following relation:
CT12/CT23<3;
wherein, CT12 represents a distance on the optical axis from an image side surface of the first lens to an object side surface of the second lens, and CT23 represents a distance on the optical axis from an image side surface of the second lens to an object side surface of the third lens.

9. The lens system according to claim 3, wherein the lens system satisfies the following relation:
2.2<FNO<6.8;
wherein, FNO represents an f-number of the lens system.

10. The lens system according to claim 3, wherein the lens system satisfies the following relation:
D32/ImgH<1.3;
wherein, D32 represents an effective half clear aperture of the third lens, and ImgH represents half of a diagonal length of an effective pixel area on an imaging plane of the lens system.

11. An imaging module, comprising a photosensitive element and the lens system according to claim 1, wherein the photosensitive element is disposed on the image side of the lens system.

12. An electronic device, comprising a housing and the imaging module of claim 11, wherein the imaging module is mounted on the housing.

13. The lens system according to claim 2, wherein the lens group comprises sequentially from the object side to the image side along the second part of the folded optical axis:
a first lens having a refractive power;
a second lens having a refractive power; and
a third lens having a refractive power;
wherein an object side surface and/or an image side surface of at least one lens of the first lens to the third lens are aspherical, and at least one surface of the object side surface and the image side surface of the at least one lens has at least one inflection point.
